(19) United States
(12) Patent Application Publication
(10) Pub. No.: US 2005/0095391 A1
(43) Pub. Date: May 5, 2005

(54) Recording medium, recording and reproducing method and recording and reproducing apparatus

(76) Inventor: Masataka Shinoda, Kanagawa (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/014,489

(22) Filed: Dec. 16, 2004

Related U.S. Application Data
(62) Division of application No. 09/896,094, filed on Jun. 28, 2001.

(30) Foreign Application Priority Data
Jun. 29, 2000 (JP) P2000-197380

(51) Int. Cl. B32B 3/02

(52) U.S. Cl. 428/64.4

(57) ABSTRACT

Information is recorded on a light transmission material such as a light transmission substrate (1) or a light transmission protecting film as a change of refractive index or a change of extinction coefficient or a change of transmittance or a change of reflectance.

### BACKGROUND OF THE INVENTION

1. Field of the Invention

The present invention relates to a recording method, a recording and reproducing method and a recording and reproducing apparatus, and particularly to a recording method, a recording and reproducing method which generically refers to either of or both of a recording method and a reproducing method and a recording and reproducing apparatus which generically refers to apparatus having function of either recording apparatus or reproducing apparatus of functions of both recording apparatus and reproducing apparatus.

2. Description of the Related Art

As a rewritable high-density optical recording system, heretofore, there is known a magneto-optical recording and reproducing system having a fundamental principle in which a magnetic thin film is partly heated in excess of a Curie temperature or a compensation temperature with application of heat energies of laser beams so that a magnetization direction is reversed to the direction of a recording magnetic field applied from the outside by decreasing or extinguishing coercive force held at that portion.

Further, as the rewritable high-density optical recording system, heretofore, there is known a phase change recording and reproducing system having a fundamental principle in which a phase change thin film is heated in excess of a crystallization temperature with application of heat energies of laser beams and thereby this portion is crystallized.

Further, as the rewritable high-density optical recording system, heretofore, there is known a magnetic recording and reproducing system having a fundamental principle in which a magnetization direction of a magnetic thin film is partly inverted with application of magnetic energies from a magnetic head.

Further, as the rewritable high-density optical recording system, heretofore, there is known a dye recording and reproducing system having a fundamental principle in which a dye thin film is partly heated with application of heat energies of laser beams and thereby this portion is evaporated or deformed.

Furthermore, as a high-density optical recording system, heretofore, there is known a reproducing system in which existence of recording pits on a recording medium is detected by reflected light or passing light.

As personal computers, the Internet and cellular phones are progressively widespread in recent years, the amount of recording information rapidly increases and circulation and distribution of a huge amount of information are advanced rapidly.

In accordance with the advance of circulation and distribution of a huge amount of information, not only communication technologies for transmitting and receiving information by telephone network lines, communication technologies for transmitting and receiving information via satellites and communication technologies for transmitting and receiving information by exclusive-telephone network lines have been put into practice.

In accordance with rapid increases of amount of recorded information, in order for consumers to record and reproduce these information, there have been put into practice mass-storage recording mediums such as a rewritable recording medium, a read-only type audio disk, a video disk and a hard disk.

On the other hand, since mass-storage recording information can be handled with ease inexpensively, technologies for maintaining securities concerning recording, storage, reproduction, circulation and distribution of information become important increasingly.

In particular, since mass-storage recording mediums can be manufactured relatively easily at low cost, there is a large risk that illegal recording mediums in which recording mediums themselves or part of or whole of recorded information on the mediums are duplicated, imitated, forged and carried away will be manufactured.

Optical recording mediums in which mass music data, mass video data, mass program data and various types of data are recorded on a recording medium by pit marks formed of very small concavities and convexities, e.g., compact disc (CD), digital video disc (DVD) and the like can be physically duplicated, imitated and forged and illegally used by disassembling and separating the recording medium.

Accordingly, in order to prevent illegally recorded information recorded on the mass-storage recording medium from being duplicated, imitated, forged and carried away, serviceability and security function of recording medium or its recording and reproducing method or its recording and reproducing apparatus have to be strengthened.

Serviceability and security function of recording medium, recording and reproducing method or recording and reproducing apparatus have been strengthened so far.

Japanese laid-open patent application No. 11-78314, for example, has described a technology in which information for ascertaining a true recording medium is printed on a recording medium and a true recording medium is judged based on this printed information for ascertaining a true recording medium.

Japanese laid-open patent application 11-66616, for example, has described a recording medium in which a laminated layer including a fluorescent layer for generating ultraviolet rays and a specific fluorescent cutoff layer is formed on a substrate, fluorescent light is generated under ultraviolet rays and recorded information may be read out visually by the naked eyes.

However, in these recording mediums, since a material of a recording medium or a substrate has to be selected separately, a film has to be separately deposited on the recording medium or the substrate and information has to be separately printed on the recording medium in order to ascertain a true recording medium, a manufacturing process of recording medium becomes complicated and a manufacturing cost of recording medium is increased inevitably.

Japanese laid-open patent application No. 11-86349 and Japanese laid-open patent application No. 11-162015 has described technologies in which a peeling preventing layer made of a resin whose elongation is large is formed on a recording layer and a protecting layer made of a resin whose elongation is small is formed on the peeling preventing layer so that physical duplication of a recording medium by disassembling or separating the recording medium can be prevented.

However, in order to prevent these recording mediums from being disassembled or separated, materials have to be selected separately and films have to be deposited separately. For this reason, the manufacturing process of recording medium becomes complicated and the manufacturing cost of recording medium increases inevitably.

Japanese laid-open patent application No. 8-124219, for example, has described a recording medium in which rims are formed around pits by irradiating laser light on the pits formed when a light transmission substrate is formed by injection molding and these pits with the rims are used as information for ascertaining a true recording medium.

Japanese laid-open patent application No. 11-120633, Japanese laid-open patent application No. 11-162026 and Japanese laid-open patent application No. 2000-82239 have disclosed technologies of recording mediums in which area having different curing degrees are partly produced in a bonding layer by irradiating electromagnetic radiation beams, which can selectively cure the bonding layer, on the bonding layer of a bonded recording medium, whereby a partial stress is produced in a reflecting layer facing the bonding layer and the reflecting layer is deformed from the original place to thereby form information for ascertaining a true recording medium.

However, in these recording mediums, since the recording pits on the recording medium or the reflecting layer facing the recording pits are deformed directly, in particular, in the case of an optical recording medium in which information is recorded and reproduced by laser light, a bad influence will be exerted upon a servo signal and a recording signal.

Japanese laid-open patent application No. 9-305697 and Japanese laid-open patent application No. 11-101690 have described methods in which spectrum information of light passed through a recording medium or light reflected on the recording medium is used as information for ascertaining a true recording medium.

However, since these recording mediums should be reproduced by a plurality of wavelengths in order to ascertain a true recording medium, a reproducing apparatus becomes complicated. Moreover, a reproducing apparatus becomes expensive.

Japanese laid-open patent application No. 11-73687 has described a method in which transmittance or reflectance of organic compound on a recording medium is used as information for ascertaining a true recording medium.

However, in these recording mediums, since materials should be selected and films should be deposited separately in order to ascertain a true recording medium, a process for manufacturing a recording medium becomes complicated, and hence the recording medium should be manufactured expensively.

Japanese laid-open patent application No. 11-154353 has described a method in which a transmittance value or a reflectance value of a recording medium substrate is used as information for ascertaining a true recording medium.

However, in these recording mediums, since a true recording medium is judged by detecting whether at least one transmittance value or reflectance value based on two wavelengths of a substrate of a recording medium is equal to a predetermined value, a third person who intends to forge the recording medium can easily measure the transmittance or the reflectance of the substrate of the recording medium. Therefore, it should be appreciated that serviceability and security function of information are not so high.

Since the substrate is formed by injection molding while pigment, dye and colors are being added to a resin which is a material of a transparent substrate in order to enable the transmittance of the substrate to have a wavelength dependence, an injection molding apparatus will be polluted by these pigment, dye and colors.

Japanese laid-open patent application No. 8-96362 has described a method in which concave and convex marks are directly formed on the recording medium by ultraviolet laser and these concave and convex marks are used as information for ascertaining a true recording medium.

However, since the concave and convex marks are directly formed on this recording medium by so-called laser abrasion such as deformation and evaporation of resin material with irradiation of ultraviolet laser beams as changes of shapes, evaporated resins are scattered to the pit marks and the guide grooves on the recording medium. As a consequence, in particular, in the case of the optical recording medium in which information is recorded and reproduced by laser light, a bad influence will be exerted upon its servo signal and recording signal.

Moreover, according to this recording method, since the concave and convex marks are physically recorded on the recording medium, a third person who intends to forge this recording medium can physically duplicate, imitate and forge the recording medium by disassembling and separating the recording medium and may use the resultant recording medium illegally.

### SUMMARY OF THE INVENTION

In view of the aforesaid aspect, it is an object of the present invention to provide a recording medium, a recording method, a reproducing method and a recording and/or reproducing apparatus in which inherent identification information, which is extremely difficult to be duplicated, imitated and forged, can be added to a recording medium or recording information when a recording medium is recorded and reproduced.

Specifically, in order to realize the above recording medium, recording method, reproducing method and recording and reproducing apparatus, as a result of various experiments, researches and examinations, the assignee of the present application has found out realization of a recording medium, a recording method, a reproducing method and a recording and reproducing apparatus in which inherent identification information, which is extremely difficult to be duplicated, imitated and forged, can be added to a recording medium and recording information by using a change of refractive index or a change of extinction coefficient of a light transmission substrate itself of a recording medium or a change of transmittance or a change of reflectance or a change of refractive index or a change of extinction coefficient of a light transmission protecting film itself of a recording medium or a change of transmittance or a change of reflectance as information, and is intended to provide a recording medium, a recording method, a reproducing method and a recording and reproducing apparatus.

In a recording medium according to the present invention, a light transmission recording material is constructed as a recording area in which information is recorded by at least one of a change of refractive index or a change of extinction coefficient or information is recorded by at least one of a change of transmittance or a change of reflectance.

A recording medium according to the present invention is a recording medium including at least a light transmission substrate or a light transmission protecting film and a recording area of information A. At least one of the light transmission substrate or the light transmission protecting film is formed as a recording area in which information B is recorded by at least one of a change of refractive index or a change of extinction coefficient or information B is recorded by at least one of a change of transmittance or a change of reflectance.

In a recording and reproducing method according to the present invention, a recording method of recording the above information B on the light transmission substrate or the light transmission protecting film of the recording medium is based on irradiation of electron beams or irradiation of light. In particular, a typical method is based on irradiation of ultraviolet rays.

This recording is based on a change of optical constant caused by irradiation of electron beams or irradiation of ultraviolet rays on the light transmission substrate or the light transmission protecting film but is not based on the change of shapes caused by laser abrasion in the conventional recording on the substrate. Further, the above recording should be distinguished from the recording executed by occurrence of chemical change caused when dye or the like is mixed into materials comprising the light transmission substrate or the light transmission protecting film.

In the recording and reproducing method according to the present invention, according to the above reproducing method of the information B, i.e., the method of reading out the information B, reproducing light, i.e., ultraviolet rays are irradiated on the recording medium as typical reproducing light and the information B is reproduced as the change of the above refractive index or the change of the extinction coefficient or the change of the transmittance or the change of the reflectance by the change of passing light amount of this reproducing light or the change of amount of reflected light.

Further, a recording and reproducing apparatus according to the present invention includes irradiating means for irradiating recording light or electron beams on the above recording medium according to the present invention, irradiating means for irradiating reproducing light and photo-detecting means. Information B is recorded on the light transmission recording material of the recording medium or the light transmission substrate or the light transmission protecting film comprising the recording medium by the change of optical constant with irradiation of recording light or with irradiation of electron beams. When the information is reproduced, reproducing light is irradiated and information is reproduced by detecting the change of amount of passing light or the change of amount of reflected light with the photo-detecting means.

Specifically, according to the present invention, inherent identification information is recorded as added information of the above information B. The information B on the recording medium according to the present invention is irreversible, stable and is not based on the information recording system effected by the change of shapes, i.e., physical concave and convex pits. Therefore, even when a third person intends to forge this recording medium by separating and disassembling the recording medium, it is extremely difficult to duplicate recorded information to other recording medium physically.

According to an aspect of the present invention, there is provided a recording medium comprising a light transmission recording material, wherein the light transmission recording material includes a recording area in which information is recorded by at least one of a change of refractive index or a change of extinction coefficient.

According to another aspect of the present invention, there is provided a recording medium which is comprised of at least one of a light transmission substrate and a light transmission protecting film and a recording area in which information A is recorded, wherein at least one of the light transmission substrate or the light transmission protecting film has a recording area in which information B is recorded by at least either a change of refractive index or a change of extinction coefficient.

Specifically, the recording medium according to the present invention include a recording area in which information B containing inherent identification information is recorded and information such as numeral, character, image and bar code which can be visually observed is recorded.

As the above information A, there are recorded at least one information or more of various information such as data information, address information, tracking information and mark information.

The above inherent identification information may be information containing at least any of management information of recording medium, management information of recording information, recording or/and reproducing disapproving information, recording medium true and false information, recording or/and reproducing number limiting information and user authentication information.

The information B may be information containing at least any one or more of various information such as the above data information, address information and tracking, and the above inherent identification information also can be recorded by a combination of information A and B. Further, the information A may contain information concerning recording of the information B, e.g., information capable of detecting the existence of the recording of information B, recording position, reproducing power and the like.

A recording medium according to an embodiment of the present invention is a recording medium using a light transmission recording material itself as an information recording material or many recording mediums including at least a light transmission substrate or a light transmission protecting film, e.g., a CD, a CD-R, a DVD disc comprised of an optical recording medium, a magnetic recording medium, a magneto-optical recording medium, a dye recording medium, a phase change recording medium or a credit card, a bank card, a money card, a commutation ticket card or the like.

A recording medium according to the present invention is comprised of the above light transmission recording material itself in which information, i.e., information B is recorded by at least one of a change of refractive index or a change of extinction coefficient or at least one of a change of transmittance or a change of reflectance.

A recording medium according to the present invention can be constructed as a recording medium including a light transmission substrate or a light transmission protecting film, for example, in which information A is formed on the above pit mark recording area by very small concave and convex patterns. Alternatively, a recording medium according to the present invention can be constructed as a recording medium in which an optical recording layer, a magnetic layer, a magneto-optical recording layer, a dye recording layer and a phase change recording layer are formed on this very small concave and convex pattern or the light transmission substrate in which this very small concave and convex pattern is not formed and in which information A is recorded.

The above light transmission recording material or the light transmission substrate in which information, e.g., information B can be recorded by the change of refractive index or the change of extinction coefficient or the change of transmittance or the change of reflectance can be made of a resin substrate of any one of polycarbonate resin, polyolefin resin, polymethyl methacrylate resin, epoxy resin and acrylic resin or glass substrate. The thickness of this light transmission substrate can be selected in a range of from about 0.3 mm to 1.2 mm, for example.

Similarly, the light transmission protecting film in which information B can be recorded by the change of refractive index or the change of extinction coefficient or the change of transmittance or the change of reflectance can be made of any one of polycarbonate resin, polyolefin resin, polymethyl methacrylate resin, epoxy resin, acrylic resin, ultraviolet-curing resin, thermosetting resin, photopolymer or sheet made of glass or coated film. The thickness of this light transmission protecting film can be selected in a range of from about 1 μto to 0.3 mm.

When information A is recorded and reproduced by irradiation of light or reproduced by irradiation of light, recording and reproducing wavelengths of irradiated light concerning the information A, wavelengths of irradiated lights concerning the information B on the above light transmission recording material, the light transmission substrate and the light transmission protecting film and wavelengths of recording/reproducing lights of the information A and the information B are selected to be different wavelengths or the same wavelength.

Specifically, when the recording area of the information A is the recording area in which the information A is recorded by irradiation of light having a wavelength λra and the information A is reproduced by irradiation of light having a wavelength λpa and the light transmission substrate or the light transmission protecting film is the light transmission substrate or the light transmission protecting film in which the information B is recorded by irradiation of light having a wavelength λrb and the information B is reproduced by irradiation of light having a wavelength λpb, each relationship of λra, λpa, λrb, λpb has any one of relationship or more of λra=λpa, λra≠λpa, λrb=λpb, λrb≠λpb, λra=λrb, λra≠λrb, λpa=λpb, λpa≠λpb, λra=λpb, λra≠λpb, λpa=λrb and λpa≠λrb.

When the recording area of the information A is the recording area in which the information A is reproduced by irradiation of light having a wavelength λpa or the information A is reproduced without irradiation of light, each relationship of λpa, λrb, λpb has any one of relationship or more of λrb=λpb, λrb≠λpb, λpa=λpb, λpa≠λpb, λpa=λrb and λpa≠λrb.

The above information B is recorded by the change of multi-value refractive index or the change of multi-value extinction coefficient or the change of multi-value transmittance or the change of multi-value reflectance.

The above information B can be recorded as information, i.e., analog information by continuous change of multi-value refractive index or continuous change of multi-value extinction coefficient or continuous change of multi-value transmittance or continuous change of multi-value reflectance.

The information B recorded by the change of the multi-value transmittance or the change of the multi-value reflectance or the information B recorded by the continuous change of the multi-value transmittance or the continuous change of the multi-value reflectance can be recorded as information containing inherent identification information and information such as numeral, character, image and bar code which can be visually observed.

When the information B is recorded in a multi-value recording fashion or in a continuous multi-value recording fashion, i.e., in an analog recording fashion, since more complex and functional information can be recorded, the recording medium according to the present invention can be used as a recording medium suitable for recording security information such as, in particular, inherent identification information.

The inherent identification information may be information containing at least any one of management information of recording medium, management information of recording medium, recording or/and reproduction disapproving information, recording medium true or false information, recording or/and reproduction number limiting information and user authentication information.

The information B can be recorded as information containing more than any one of various information such as the above data information, address information and tracking information, and the above inherent identification information can be recorded by a combination of information A and information B. Further, the information A can contain information concerning recording of the information B, e.g., information capable of detecting existence of recording of information B, recording position, reproducing power and the like.

The above information B is recorded by irradiation of electron beams or by irradiation of light, and it is desirable that irradiation of light should be executed by irradiation of ultraviolet rays.

When information B is reproduced, reproducing light is irradiated on the recording medium and information B is reproduced by a change of amount of passing light of this reproducing light or a change of amount of reflected light.

When the information A and the information B are reproduced, after the information B has been reproduced, the information A can be recorded or/and reproduced based on this reproduced information, for example.

A recording and reproducing apparatus according to the present invention includes a light source section for irradiating at least one of a light transmission substrate or a light transmission protecting film of a recording medium with recording light based on ultraviolet light with a pattern corresponding to information B. By recording light from this light source section, information B is recorded as a change of refractive index or a change of extinction coefficient or a change of transmittance or a change of reflectance relative to the light transmission substrate and the light transmission protecting film.

This light source section may include a ultraviolet ray light-emitting laser or a ultraviolet ray light-emitting lamp.

Further, the light source section may include a ultraviolet ray light-emitting lamp and a photo-mask with a pattern corresponding to information B.

Furthermore, information B can be recorded in a multi-value recording fashion and in a continuous multi-value recording fashion.

A recording and reproducing apparatus according to the present invention may include a light source section for irradiating the inventive recording medium with reproducing light and a photo-detecting means for detecting a change of passing light amount of reproducing light passed through the light transmission substrate or the light transmission protecting film of the recording medium or a change of reflected light amount.

This reproducing light may have a wavelength longer than 200 nm and shorter than 500 nm, for example.

The photo-detecting means can be comprised of a solid-state imaging device, e.g., a CCD (charge-coupled device) camera or a CMOS (complementary metal-oxide semiconductor) camera or a photodetector such as a silicon photodiode.

Further, the recording and reproducing apparatus according to the present invention may include an objective lens. This objective lens may focus ultraviolet ray laser light from the light source section on the above inventive recording medium to obtain focusing and tracking servo signals.

Furthermore, the recording and reproducing apparatus according to the present invention may include a light source section for generating recording and reproducing light of information A and a light source section for generating recording and reproducing light of information B so that the recording and reproducing light of information A and the recording and reproducing light of information B may have different wavelengths or the same wavelength.

Specifically, as mentioned before, when the recording area of information A is the recording area in which information A is recorded by irradiation of light having a wavelength λra and information A is reproduced by irradiation of light having a wavelength λpa and the light transmission substrate or the light transmission protecting film is the light transmission substrate or the light transmission protecting film in which information B is recorded by irradiation of light having a wavelength λrb and information B is reproduced by irradiation of light having a wavelength λpb, relationships of the respective wavelengths λra, λpa, λrb, λpb of the respective recording and reproducing light source sections can be selected to be any one of more of λra=λpa, λra≠λpa, λrb=λpb, λrb≠λpb, λra=λrb, λra≠λrb, λpa=λpb, λpa≠λpb, λra=λpb, λra≠λpb, λpa=λrb, λpa≠λrb.

When the recording area of information A is the recording area in which information A is reproduced by irradiation of light having a wavelength λpa or information A is reproduced without irradiation of light, λpa, λrb, λpb may contain any one of more of relationships of λrb=λpb, λrb≠λpb, λpa=λpb, λpa≠λpb, λpa=λrb, λpa≠λrb.

When the recording area of information A is a recording area in which information A is recorded by irradiation of light having a wavelength λra and information A is reproduced by irradiation of light having a wavelength λpa and the light transmission substrate or the light transmission protecting film is a light transmission substrate or a light transmission protecting film in which information B is recorded by irradiation of light having a wavelength λrb and information B is reproduced by irradiation of light having a wavelength λpb, it is desirable that transmittance of the light transmission substrate or the light transmission protecting film relative to light having a recording wavelength λpa of information A and light having are producing wavelength λpa of information A should be higher than 50%.

The reason for this will be described below. That is, when information A is recorded or reproduced by irradiation of light, light irradiation energy can be supplied to the information A efficiently. When transmittance becomes less than 50%, the light irradiation light source needs large power. Therefore, when a semiconductor laser, for example, is used as a light source, a making current increases so that a lifetime of semiconductor is shortened inevitably.

Similarly, when the recording area of information A is a recording area in which information A is recorded by irradiation of light having a wavelength λra and information A is reproduced by irradiation of light having a wavelength λpa and the light transmission substrate or the light transmission protecting film is a light transmission substrate or a light transmission protecting film in which information B is recorded by irradiation of light having a wavelength λrb and information B is reproduced by irradiation of light having a wavelength λpb, it is desirable that transmittance of the light transmission substrate or the light transmission protecting film relative to light having a recording wavelength λrb of information B is selected to be under 50%.

The reason for this will be described below. That is, when information B is recorded, if transmittance is selected to be higher than 50%, then since transmittance of recording light is large and energy is absorbed inefficiently, recording efficiency is lowered and the light irradiation light source needs large power. Therefore, when a semiconductor laser, for example, is used as a light source, a making current increases so that a lifetime of semiconductor is shortened inevitably.

Furthermore, when the recording area of information A is a recording area in which information A is recorded by irradiation of light having a wavelength λra and information A is reproduced by irradiation of light having a wavelength λpa and the light transmission substrate or the light transmission protecting film is a light transmission substrate or a light transmission protecting film in which information B is recorded by irradiation of light having a wavelength λrb and information B is reproduced by light having a wavelength λpb, it is desirable that transmittance of the light transmission substrate or the light transmission protecting film relative to light having a reproducing wavelength λpb of information B is selected to be above 50%.

The reason for this will be described below. When transmittance is less than 50%, a loss of reproducing light increases. As a consequence, in order to obtain a high S/N (signal-to-noise ratio) or a high C/N (carrier-to-noise ratio), and the light irradiation light source needs large power. Therefore, when a semiconductor laser, for example, is used as a light source, a making current increases so that a lifetime of semiconductor is shortened inevitably.

### BRIEF DESCRIPTION OF THE DRAWINGS

FIG. 1 is a schematic cross-sectional view showing an example of a recording medium according to the present invention;

FIG. 2 is a schematic cross-sectional view showing an example of a recording medium according to the present invention;

FIG. 3A is a schematic cross-sectional view showing an example of a recording medium according to the present invention;

FIG. 3B is a schematic cross-sectional view showing an example of a recording medium according to the present invention;

FIG. 4A is a schematic cross-sectional view showing an example of a recording medium according to the present invention;

FIG. 4B is a schematic cross-sectional view showing an example of a recording medium according to the present invention;

FIG. 5A is a schematic cross-sectional view showing an example of a recording medium according to the present invention;

FIG. 5B is a schematic cross-sectional view showing an example of a recording medium according to the present invention;

FIG. 6 is a schematic cross-sectional view showing an example of a recording medium according to the present invention;

FIG. 7 is a schematic cross-sectional view showing an example of a recording medium according to the present invention;

FIG. 8 is a schematic perspective view showing an example of a recording medium according to the present invention;

FIG. 9 is a schematic perspective view showing an example of a recording medium according to the present invention;

FIG. 10 is a schematic perspective view to which reference will be made in explaining the manner in which information is recorded on a recording medium according to an embodiment of the present invention;

FIG. 11 is a schematic perspective view to which reference will be made in explaining the manner in which information is recorded on a recording medium according to an embodiment of the present invention;

FIG. 12A is a schematic perspective view to which reference will be made in explaining the manner in which information is reproduced from a recording medium according to an embodiment of the present invention:

FIG. 12B is a diagram to which reference will be made in explaining a detected amount of reflected light;

FIG. 13A is a schematic perspective view to which reference will be made in explaining the manner in which information is reproduced from a recording medium according to an embodiment of the present invention;

FIG. 13B is a diagram to which reference will be made in explaining a detected amount of reflected light;

FIG. 14 is a block diagram showing an example of an information recording apparatus according to the present invention;

FIG. 15 is a block diagram showing an example of an information reproducing apparatus according to the present invention;

FIG. 16 is a block diagram showing an example of an information reproducing apparatus according to the present invention;

FIGS. 17A to 17E are diagrams to which reference will be made in explaining recorded information and the manner in which signals are detected according to the present invention, respectively;

FIG. 18 is a top view of a recording medium and to which reference will be made in explaining the position at which information B is stored in a recording medium according to the present invention;

FIG. 19 is a diagram showing measured results of wavelength dependence of transmittance obtained before and after recording medium samples are irradiate with ultraviolet rays;

FIG. 20 is a diagram showing measured results of wavelength dependence of refractive index obtained before and after recording medium samples are irradiated with ultraviolet rays;

FIG. 21 is a diagram showing measured results of wavelength dependence of extinction coefficient obtained before and after recording medium samples are irradiated with ultraviolet rays;

FIGS. 22A and 22B are diagrams showing the states of recorded information obtained when ultraviolet rays are irradiated on the light transmission substrate or when ultraviolet rays are not irradiated on the light transmission substrate, respectively;

FIG. 23 is a block diagram showing an example of a reproducing apparatus according to the present invention;

FIG. 24 is a diagram showing a reproduced signal obtained when an amount of reflected light obtained from a recording medium is detected according to the present invention;

FIG. 25 is a diagram showing a reproduced signal obtained when an amount of reflected light obtained from a recording medium is detected according to the present invention;

FIG. 26 is a diagram showing a reproduced signal obtained when an amount of reflected light obtained from a recording medium is detected according to the present invention;

FIG. 27 is a diagram showing a reproduced signal obtained when an amount of reflected light obtained from a recording medium is detected according to the present invention;

FIG. 28 is a diagram showing a reproduced signal obtained when an amount of reflected light obtained from a recording medium is detected according to the present invention;

FIG. 29 is a diagram showing measured results of recording length dependence of information B relative to the change of an amount of reflected light according to the present invention;

FIG. 30A is a diagram showing a reproduced signal of recording mark trains obtained when a recording medium is reproduced in a first reproduction;

FIG. 30B is a diagram showing a reproduced signal of recording mark trains obtained when a recording medium is reproduced in a hundred thousandth reproduction;

FIG. 31 is a diagram showing reflected light amount amplitude and the number of times of reproduction of a recording medium according to the present invention;

FIGS. 32A to 32C are diagrams showing reproduced signals obtained by reflected light of a recording medium according to the present invention, respectively;

FIG. 33 is a diagram showing a wavelength dependence of transmittance measured in accordance with ultraviolet ray irradiation time;

FIG. 34 is a diagram to which reference will be made in explaining information multi-value recording based on changed amount of transmittance;

FIG. 35 is a perspective view showing multi-value recording state of information based on changed amount of transmittance;

FIG. 36 is a diagram to which reference will be made in explaining multi-value recording state of information based on changed amount of transmittance;

FIG. 37 is a diagram showing a wavelength dependence of transmittance measured after ultraviolet rays had been irradiated on the recording medium;

FIG. 38 is a diagram to which reference will be made in explaining reproducing methods with a plurality of wavelengths using a wavelength dependence of transmittance;

FIG. 39 is a perspective view to which reference will be made in explaining reproducing methods with a plurality of wavelengths using a wavelength dependence of transmittance;

FIGS. 40A and 40B are diagrams to which reference will be made in explaining reproducing methods with a plurality of wavelengths using a wavelength dependence of transmittance, respectively;

FIGS. 41A and 41B are diagrams to which reference will be made in explaining reproducing methods with a plurality of wavelengths using a wavelength dependence of transmittance, respectively;

FIG. 42 is a schematic diagram to which reference will be made in explaining reproducing methods with a plurality of wavelengths using a wavelength dependence of transmittance;

FIG. 43 is a schematic diagram to which reference will be made in explaining a method of reproducing information by using reproducing light having a plurality of wavelengths;

FIG. 44 is a schematic diagram to which reference will be made in explaining a method of reproducing information by using reproducing light having a plurality of wavelengths;

FIG. 45 is a diagram showing a wavelength dependence of transmittance obtained before and after irradiation of ultraviolet rays;

FIG. 46 is a diagram showing a wavelength dependence of refractive index obtained before and after irradiation of ultraviolet rays; and

FIG. 47 is a diagram showing a wavelength dependence of extinction coefficient obtained before and after irradiation of ultraviolet rays.

### DESCRIPTION OF THE PREFERRED EMBODIMENTS

The present invention will now be described with reference to the accompanying drawings.

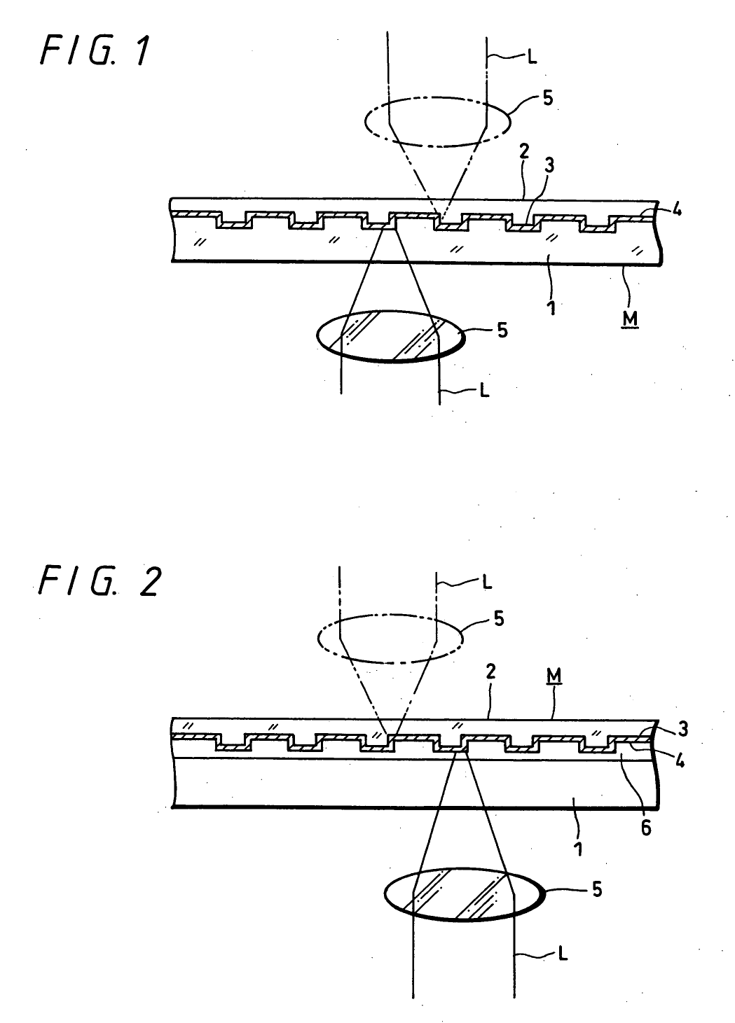

FIG. 1 is a schematic cross-sectional view showing a ROM (read-only memory) type recording medium, e.g., RM disk. In this example, as shown in FIG. 1, a light transmission substrate 1 made of a polycarbonate (PC) substrate having a recording area 3 of information A formed by very small concavities and convexities such as recording pits and recording grooves of information A is formed by injection molding. A reflecting film 4 is formed on the surface in which very small concavities and convexities of the substrate 1 comprising the recording area 3 of the information A, i.e., the recording area of the information A is formed. A light transmission protecting film 2 is formed on this reflecting film 4.

When information A is read out from this recording medium M at its recording area 3 of the information A, laser light L from the light transmission substrate 1 side is focused on the recording area 3 by an objective lens 5 and information is read out by detecting changes of amounts of reflected light generated due to interference on very small concavities and convexities.

Alternatively, as shown by dots-and-dash lines in FIG. 1, laser light L is focused on the recording area 3 from the light transmission protecting film 2 aide by the objective lens 5 and information is read out by detecting changes of amounts of reflected light generated due to interference on very small concavities and convexities. When information is read out by the irradiation of laser beams from the light transmission protecting film 2 side, the light transmission protecting film 2 has a sufficiently thin thickness as compared with the light transmission substrate 1 so that the objective lens 5 and the recording area 3 are located close to each other. As a result, the numerical aperture of the objective lens can be increased and the diameter of the beam spot can be reduced, whereby a recording density can be improved.

FIG. 2 is a schematic cross-sectional view of a recording medium M. As shown in FIG. 2, in this recording medium M, a material layer 6 made of ultraviolet-curing resin, for example, is formed on the light transmission substrate 1 and a recording area 3 having information Abased on very small concavities and convexities is formed on the material layer 6 by a 2P method (photopolymerization method).

Also in this case, a reflecting film 4 is formed on the light transmission substrate 1 at its surface in which very small concavities and convexities are formed, i.e., at its surface in which the recording area of the information A is formed. A light transmission protecting film 2 is formed on the reflecting film 4.

When the information A is read out from the recording medium M shown in FIG. 2 at its recording area 3, laser light L from the light transmission substrate 1 side, for example, is focused on the recording area 3 by the objective lens 5 and information is read out by detecting changes of amounts of reflected light due to interference generated by very small concavities and convexities.

Alternatively, as shown by dot-and-dash lines in FIG. 2, laser light L is focused on the recording area 3 from the light transmission protecting film 2 side by the objective lens 5 and information is read out by detecting changes of amounts of reflected light generated due to interference on very small concavities and convexities.

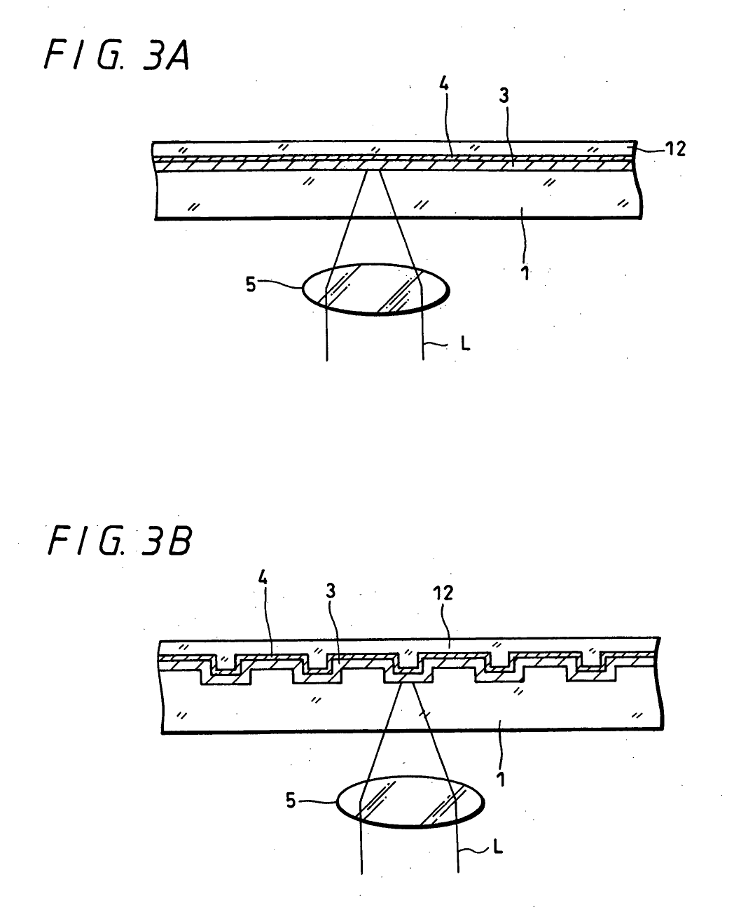

FIG. 3A is a schematic cross-sectional view of a recording medium. As shown in FIG. 3A, a rewritable recording layer or a write once recording layer such as the aforementioned magneto-optical recording layer, the dye recording layer and the phase change recording layer comprising the recording area 3 of the information A is formed on the light transmission substrate 1. A protecting film 12 is formed on the surface of such recording layer.

The recording layer comprising this recording area 3 is not limited to a single layer structure and may be formed as a laminated structure of material layers of multilayers. In order to improve recording and reproducing characteristics of these recording layers, there can be used a laminated structure in which a material layer of a dielectric film such as SiN, AlN, ZnS—SiO₂ and SiC, a metal film such as aluminum, gold, silver, copper and silicon is formed as a light interference layer and a material layer of a dielectric film such as SiN, AlN, ZnS—SiO₂, SiC and a metal film such as aluminum, gold, silver, copper, platinum and silicon is formed as a heat control layer.

These recording layer and material layer can be formed by a film forming apparatus such as a sputtering apparatus, an evaporating apparatus and a coating apparatus.

The reflecting film 4 having a proper reflectance is formed by depositing aluminum, gold, silver, copper, platinum and an alloy of these metals.

The information A is recorded on and reproduced from the recording medium shown in FIG. 3 by focusing laser light L, for example, from the light transmission substrate 1 side by the objective lens 5.

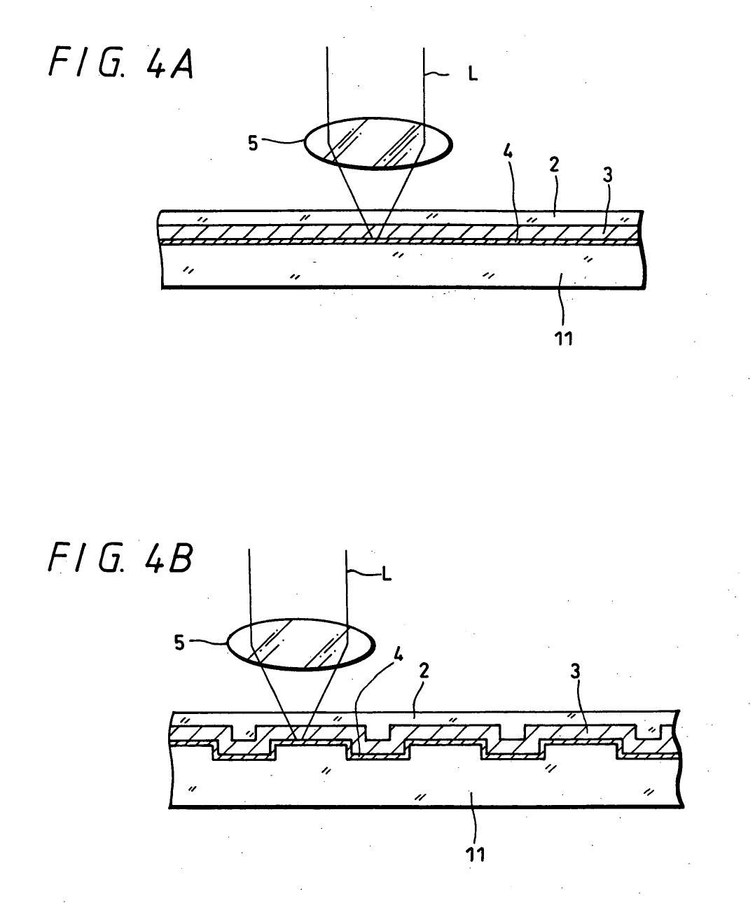

FIG. 4A is a schematic cross-sectional view showing an arrangement of a recording medium. As shown in FIG. 4A, in this recording medium M, a reflecting film 4 is formed on a substrate 11 which is not limited to a light transmission substrate. A rewritable recording layer such as the aforementioned magneto-optical recording layer, the dye recording layer and the phase change recording layer comprising the recording area 3 of the information A that had been described with reference to FIG. 3, for example, or a write once recording layer is formed on the reflecting layer 4. Then, in this case, a light transmission protecting film 2 is formed on the surface of the recording layer.

The information A is recorded on and reproduced from this recording medium MK by focusing laser light L, for example, from the light transmission protecting film 2 side by an objective lens 5.

As shown in FIGS. 3B and 4B, grooves for tracking servo may be formed on the light transmission substrate 1 or on the light transmission protecting film 2 side as shown in FIG. 2.

In FIGS. 3B and 4B, elements and parts identical to those of FIGS. 3A and 4A are marked with the identical reference numerals and therefore need not be described.

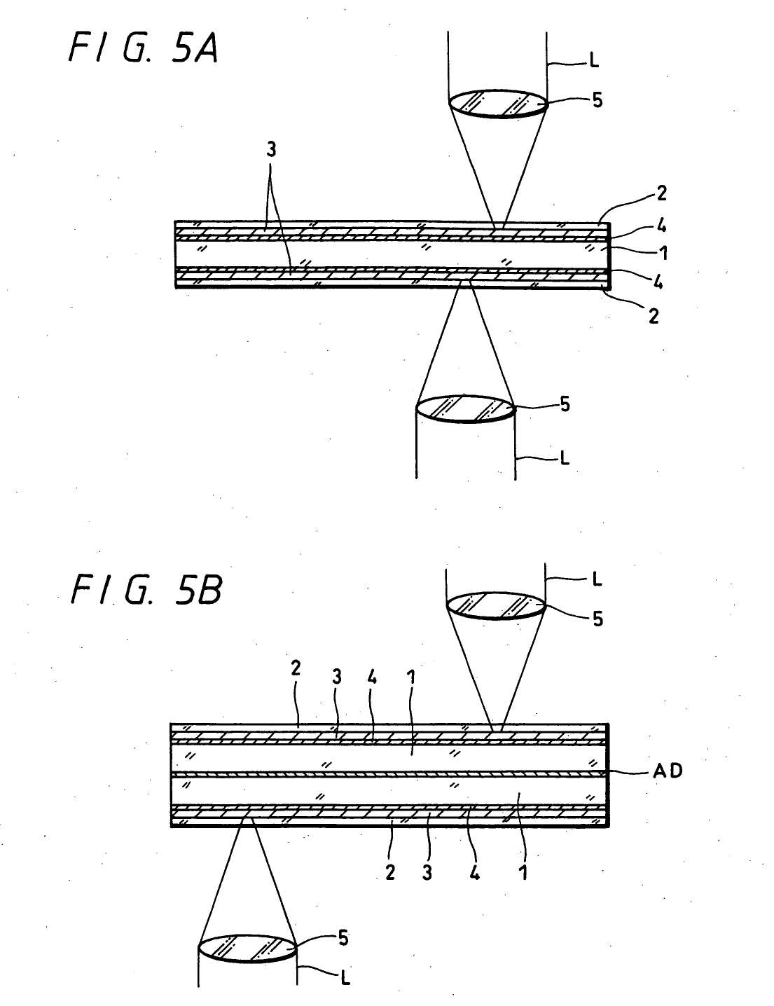

FIG. 5A is a schematic cross-sectional view of a recording medium M. As shown in FIG. 5A, this recording medium M has an arrangement in which two recording areas 3 in which information A can be recorded are formed on both surfaces. In this case, recording layers comprising the recording area 3 similar to those of FIGS. 4A and 4B can be respectively formed on both opposing major surfaces of a light transmission substrate 1. Alternatively, as shown in a schematic cross-sectional view of FIG. 5B, recording layers and the like comprising the recording area 3 may be formed on one surface of two light transmission substrates 1 or sheet-like light transmission protecting films and attached together by an attachment layer AD such as a ultraviolet-curing resin or a thermosetting resin. Then, information A can be recorded on and reproduced from both surfaces of this recording medium M by focusing laser light L, for example, through an objective lens 5.

In FIGS. 5A and 5B, elements and parts identical to those of FIGS. 4A and 4B are marked with the identical reference numerals and therefore need not be described.

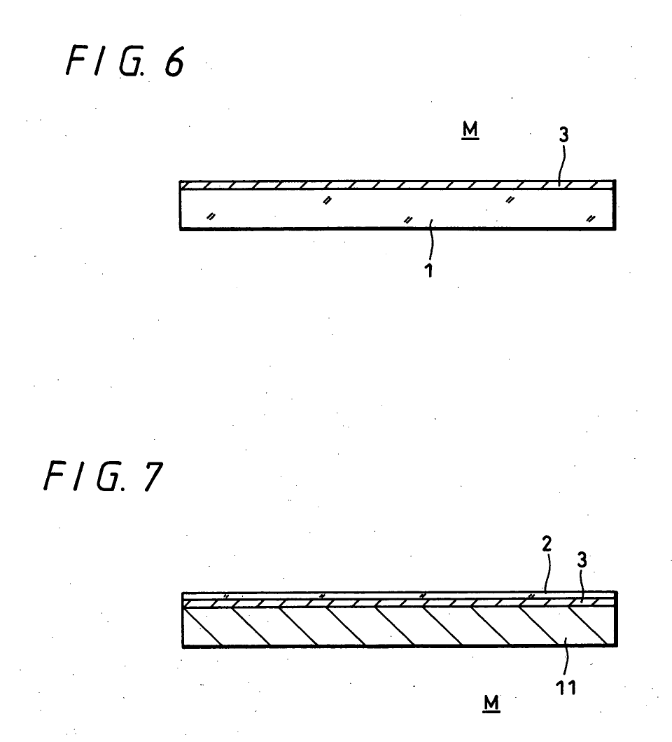

The recording medium M according to the present invention is not limited to the recording medium in which the information A is reproduced or recorded and reproduced optically. FIG. 6 is a schematic cross-sectional view of a recording medium M, for example. As shown in FIG. 6, this recording medium M has an arrangement in which a recording area 3 formed of a magnetic layer in which information A is recorded and reproduced may be formed on a light transmission substrate 1.

Alternatively, FIG. 7 is a schematic cross-sectional view of a recording medium M. As shown in FIG. 7, a recording area 3 made of a magnetic layer to record and reproduce information A can be formed on a substrate 11 which is not limited to a light transmission substrate, for example, and a light transmission protecting film 2 can be formed on the recording area 3.

The recording mediums M shown in FIGS. 6 and 7 can be constructed as a so-called hard disk.

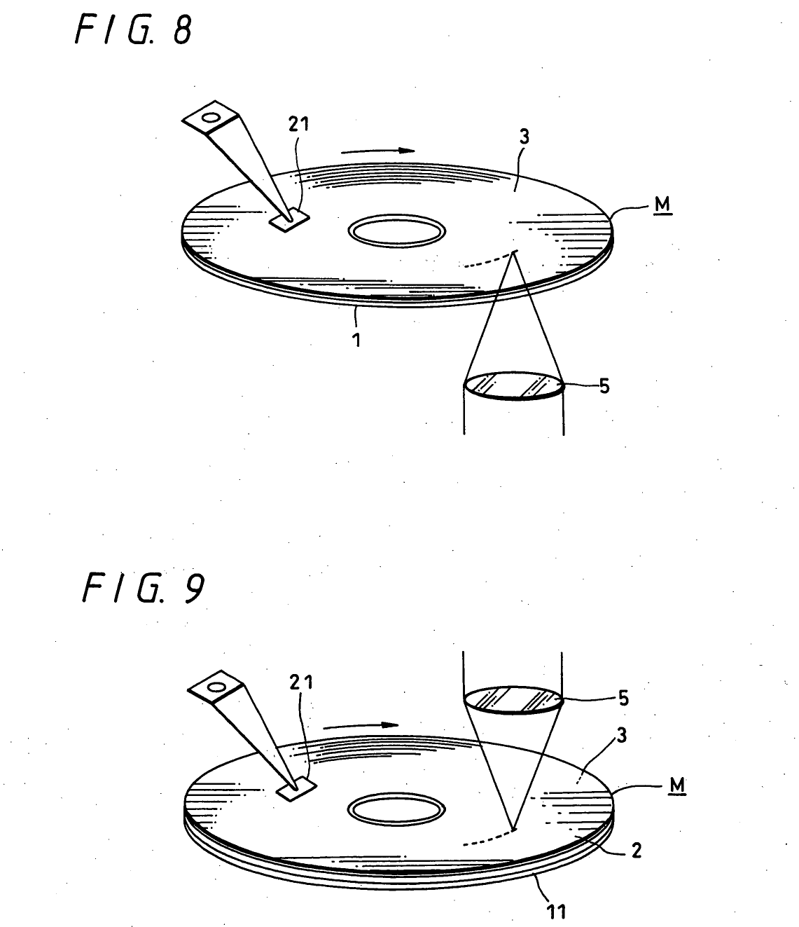

Information A can be recorded on and reproduced from the recording areas 3 of these recording mediums M when a magnetic head 21 traces the recording areas 3 formed of the magnetic layer as shown in FIGS. 8 and 9, respectively. This magnetic head 21 can be comprised of a flying type magnetic head, for example. Specifically, this magnetic head 21 includes a slider and this slider is floated by air flow generated by rotation of the recording medium M, i.e., disk, whereby a head element disposed on this slider scans the recording area 4 in an annular fashion or a spiral fashion through so-called air-bearing relative to the magnetic layer, i.e., the recording area 3. As a result, information A can be recorded and information A can be reproduced along this scanning locus.

The light transmission protecting film 2 in the above respective recording mediums M may be comprised of the sheets of the aforementioned respective materials or coated films.

The manner in which information is recorded on recording mediums according to the present invention will be described next.

Information A can be recorded on the respective recording mediums M shown in FIGS. 1 to 7 by an ordinary method.

Specifically, in the arrangements of FIGS. 1 and 2, in the manufacturing process of a stamper used when very small concavities and convexities forming the recording area 3 are formed by injection molding, for example, or 2P method, i.e., in the mastering process, concave and convex patterns are formed as patterns corresponding to the information A.

When information A is recorded on the recording mediums M shown in FIGS. 3 to 5, a light or heat pattern is applied to the recording layer in response to the recording information A so that information A is recorded on the recording medium A by the change of shape, the chemical reaction, the change of crystal to amorphous substance, the change of magnetization direction and the like.

Further, information A is recorded on the recording mediums M shown in FIGS. 6 and 7 by the change of magnetization direction with the aforementioned magnetic head 21.

The aforementioned information B should preferably be recorded on the light transmission substrate 1 and the light transmission protecting film 2 of the above respective recording mediums M by the irradiation of ultraviolet rays. The reason for this is that most of substance can absorb light well in the wavelengths of ultraviolet ray region so that the light transmission substrate 1 and the light transmission protecting film 2 can be changed chemically and physically independently of the materials comprising the target light transmission substrate 1 and light transmission protecting film 2 without causing the mechanical change.

The recording based on the irradiation of ultraviolet rays can be carried out by modulation of anyone of irradiation time, intensity, irradiation area or both of them.

Information B can be recorded on the light transmission substrate 1 and the light transmission protecting film 2 in response to the arrangement of the recording medium M under the condition that the recording medium M is completed before or after information A is recorded. In addition, under the condition that the recording medium M is half completed or under the condition that the respective material layers for the light transmission substrate 1 and the light transmission protecting film 2 are not yet formed, information B can be recorded.

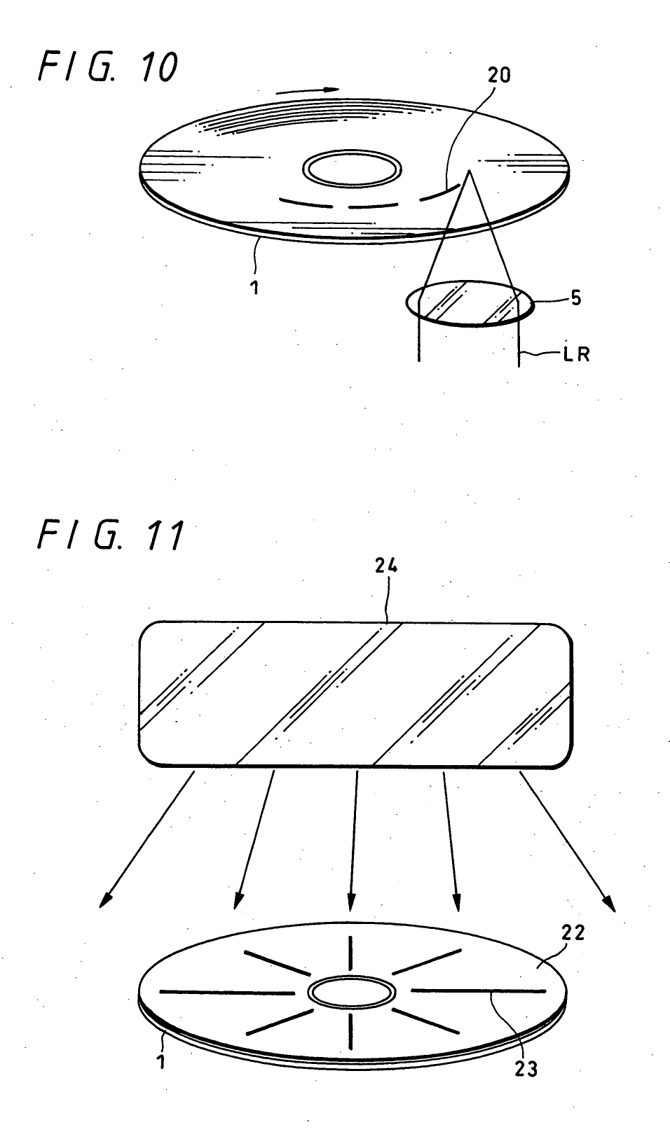

When this information B is recorded, as shown in FIG. 10, for example, under the condition that the recording medium M, for example, is rotated, spots of ultraviolet laser LR are irradiated on the recording medium M with patterns corresponding to recording information, whereby a recording portion 20 of information B is formed based on the change of refractive index or the change of extinction coefficient or the change of transmittance or the change of reflectance. According to this method, the recording pattern 20 become arcuate. At that time, the incident surface of the ultraviolet laser LR can be formed on the light transmission substrate side or on the opposite side in which the recording layer is formed.

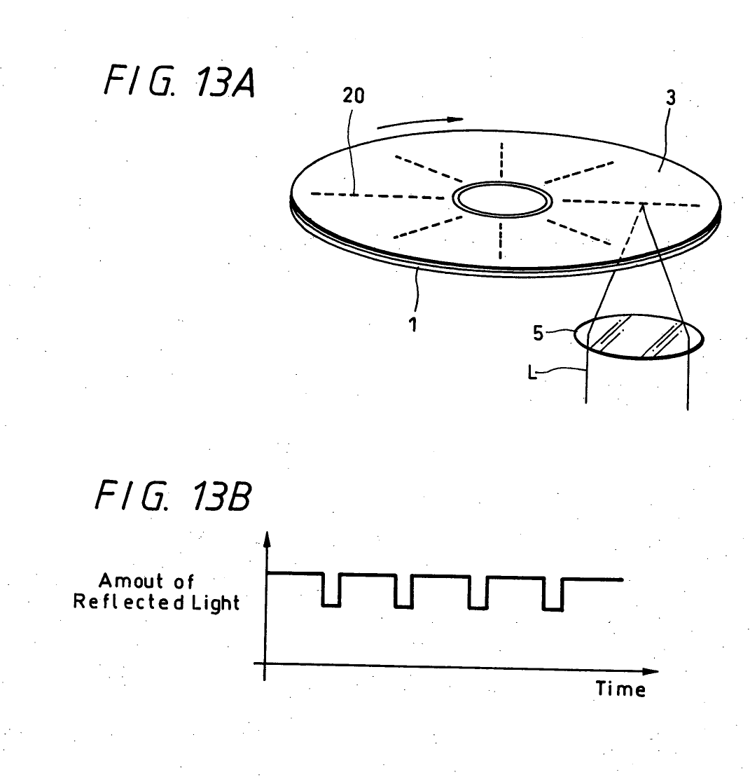

This information B can be recorded by using a ultraviolet lamp. In this case, as shown in FIG. 11, for example, a photo-mask 22 having mask effects relative to ultraviolet rays and which has a transmission pattern 23 for passing ultraviolet rays corresponding to the pattern of recorded information B is located adjacent to or in an opposing relation to the recording area side of the information A, i.e., the surface side in which the recording layer is formed or the opposite light transmission substrate 1 or the opposite light transmission protecting film 2 side. Then, a recording portion 20 of information B shown in FIG. 13, for example, is formed by irradiating ultraviolet rays from the ultraviolet lamp 24 through this photo-mask 22.

If there are prepared a plurality of kinds of photo-masks 22 or a plurality of photo-masks 22 and they are combined, then information B of various patterns can be recorded.

The above recording portion 20 of the information B can be formed, as mentioned before, under the condition that the recording layer comprising the recording area 3 of the information A and the like are not formed. In this case, the recording layer and the like are deposited after the recording portion 20 had been formed.

Further, the information B can be recorded in a multilevel recording fashion. In this multilevel recording, more than one of ultraviolet ray irradiation time, irradiation intensity and irradiation amount of light are changed in response to recording information, whereby recording in which the changed amount of refractive index or the changed amount of extinction coefficient are different or in which the changed amount of light transmittance of the changed amount of reflectance are different can be carried out. Then, this changed amount can be changed in a stepwise fashion, i.e., in a digital fashion or this changed amount can be changed continuously, i.e., in an analog fashion, thereby making it possible to carry out continuous multilevel recording.

Next, a reproducing method will be described.

When the information A is reproduced from the recording area 3 of each recording medium M with irradiation of light, e.g., with irradiation of laser light similarly to the ordinary fashion or based on the magnetic recording layer shown in FIGS. 6 and 7, the information A can be reproduced from the recording area 3 by a magnetic head.

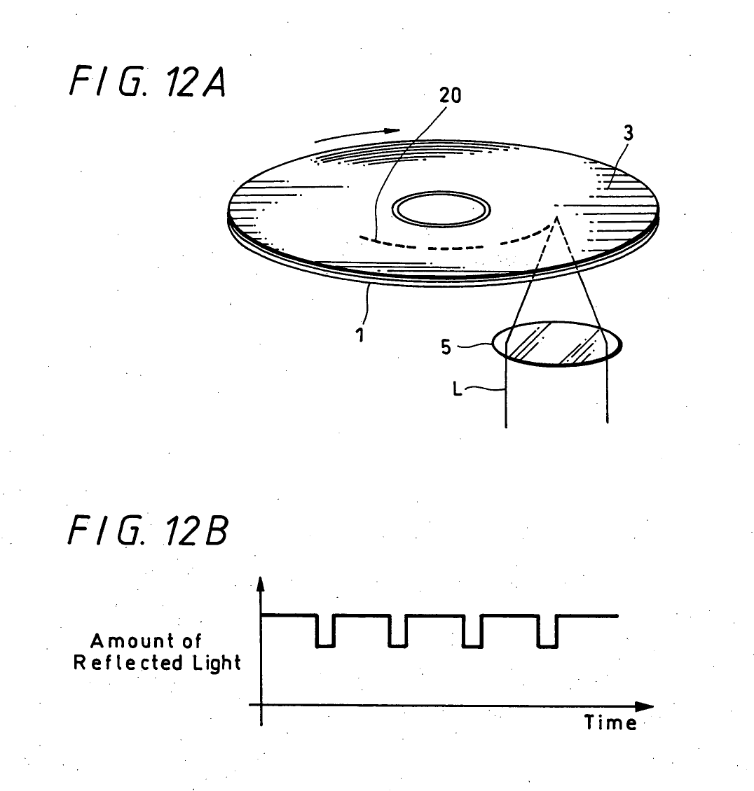

When this information B is read out from the recording medium M, i.e., the recording portion 20 is reproduced, as shown in FIG. 12A or FIG. 13A, for example, while the recording medium M, for example, is being rotated, the light transmission substrate 1 or the light transmission protecting film 2 is scanned by spot of reproducing light L and reflected light, for example, of reproducing light L from the recording portion 20 of the information B recorded as a change of refractive index or a change of extinction coefficient or a change of transmittance or a change of reflectance of the light transmission substrate 1 or the light transmission protecting film 2 is detected so that the information B can be detected, i.e., reproduced with detection light amounts shown in FIGS. 12B and 13B.

Further, when the information B recorded stepwise or continuously in a multi-value recording fashion is reproduced, reflected light, for example, of reproduced light L from the recording portion 20 of information recorded as a change of refractive index or a change of extinction coefficient or a change of transmittance or a change of reflectance is detected so that the information B can be similarly detected, i.e., reproduced by the change of detection light amount.

Next, a recording apparatus and a reproducing apparatus will be described.

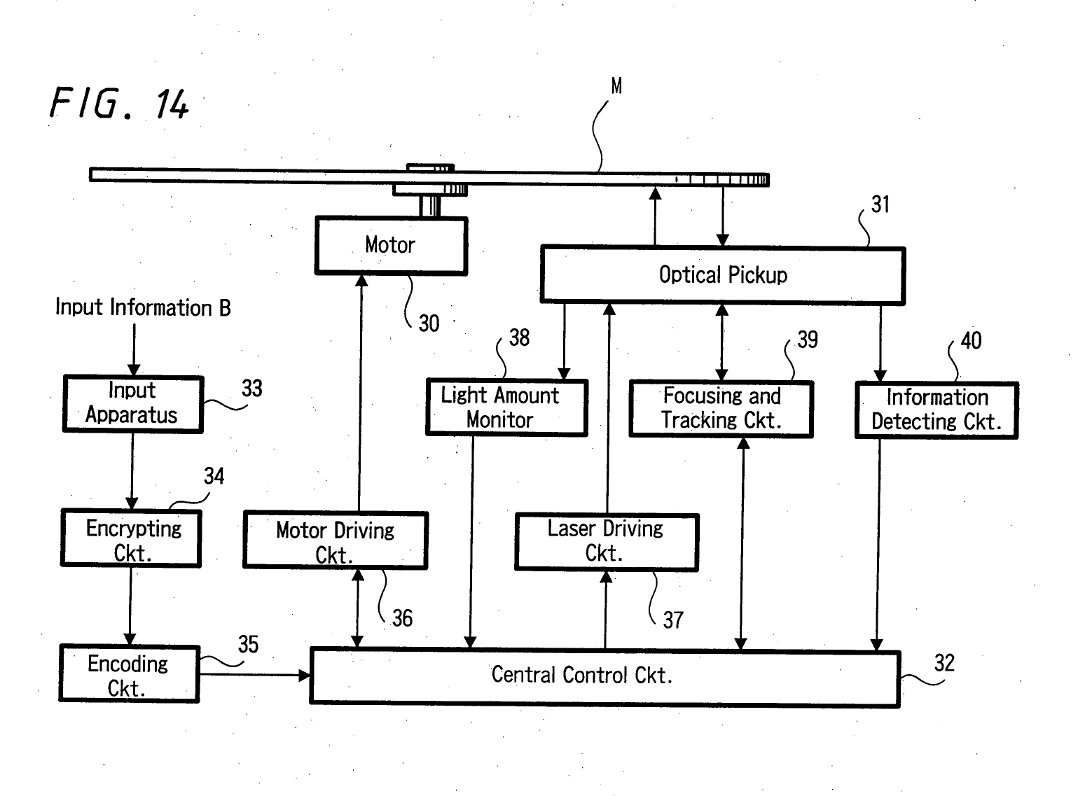

FIG. 14 is a schematic block diagram showing an example of a recording apparatus.

In this example, the information B is recorded on the light transmission substrate 1 or the light transmission protecting film 2 of the recording medium M by the optical recording method.

The information A and the information B can be recorded on the recording medium M at overlapping positions along the thickness direction or the information B, for example, can be recorded at a specified position such as the inner peripheral side or the outer peripheral side from the recording area range of the information A. Alternatively, when grooves of very small concavities and convexities are formed on the light transmission substrate 1 or the light transmission protecting film 2, the information A can be recorded on one of the grooves and the land portion and the information B can be recorded on the other.

In this example, the recording medium M is the disk-like recording medium and is rotated by a motor 30.

Alight irradiating means, i.e., optical pickup 31 is provided relative to this recording medium M.

Although not shown, this optical pickup 31 has a fundamental arrangement corresponding to an optical pickup 31 in an ordinary optical recording medium. In this case, this optical pickup comprises a light source section for generating recording light, e.g., light source section having a ultraviolet laser, the aforementioned objective lens 5 disposed on an actuator for adjusting focusing and adjusting tracking, various lenses for forming optical path, a beam splitter, an optical system such as a reflecting mirror, a detecting section for detecting a focusing error and a tracking error, a photo-detecting means for detecting returned light (reflected light) from the recording medium M and converting the detected light into an electrical signal, e.g., photodetector such as a photodiode.

As mentioned before, when ultraviolet rays are used as recording light of the light source section, recording light can be irradiated on smaller are as a thigh energy density with higher accuracy.

As this ultraviolet laser, there can be used a YAG (yttrium aluminum garnet) laser and a laser based on a nonlinear optical crystal capable of generating ultraviolet ray laser beams having a wavelength of 266 nm by effectively utilizing wavelength conversion. The present invention is not limited to the above lasers and various types of lasers can be applied to the present invention so long as lasers are able to generate ultraviolet ray light.

As shown in FIG. 14, in this recording apparatus, there is provided a central control circuit 32.

Recorded information B is inputted to an input apparatus 33, encrypted by an encrypting circuit 34 and then encoded by an encoding circuit 35. The signal thus encoded is inputted to the central control circuit 32.

In order to record the inputted information on the inventive recording medium M, the central control circuit 32 controls a motor driving circuit 36 of a rotary motor 30 of the recording medium KM and a laser driving circuit 37 for driving the ultraviolet ray laser of the optical pickup 31.

Simultaneously, this central control circuit 32 monitors and controls a monitor signal from a light amount monitor 38 in order to monitor whether or not information is recorded properly and also monitors and controls servo signals from a focus and tracking monitor 39 in order to monitor whether or not information is recorded at a target position.

The inputted information introduced from the encoding circuit 35 into the central control circuit 32 is converted by the laser driving circuit 37 into laser beams of the light source section of the optical pickup 31, in this example, ultraviolet ray laser light and thereby recorded on the inventive recording medium M.

An emission intensity of laser light and an emission time obtained at that time are monitored by the light amount monitor 38 and their information are fed back to the central control circuit 32. The position at which the recorded information is recorded on the recording medium M is controlled by servo signals obtained during focusing and tracking. It is confirmed by an information detecting circuit 40 whether or not the recorded information is correct.

In this manner, the information B is sequentially recorded at predetermined positions.

Then, when the information B is recorded by the optical pickup 31, the information B can be recorded in a stepwise fashion or in a continuous multi-value recording fashion by changing the irradiation time, the light amount, the irradiation intensity of ultraviolet rays and the like in response to the inputted information B.

While information is recorded by laser beams from the ultraviolet ray laser as described above, as described with reference to FIG. 13, according to the method of recording information B by an ultraviolet lamp, the light source section of the optical pickup includes the ultraviolet ray lamp and information is recorded with a predetermined pattern on a large area at uniform energy density by irradiation of ultraviolet rays generated from the ultraviolet lamp through the aforementioned photo-mask 22.

As the ultraviolet lamp, there can be used various ultraviolet lamps such as a low pressure mercury lamp, a high pressure mercury lamp, an extra-high pressure mercury lamp and a xenon lamp capable of generating ultraviolet rays.

When a wavelength of light emitted from a ultraviolet lamp, in particular, or a ultraviolet laser is short, in order to prevent air from absorbing ultraviolet rays so that ultraviolet rays can be irradiated on a recording medium at high efficiency, laser light can be generated from the ultraviolet laser in the atmosphere in which ultraviolet rays are less absorbed, e.g., in the atmosphere of nitrogen and the like.

As the recording method and the recording apparatus for recording the information A, there can be used ordinary recording method and recording apparatus. Part of or whole of the above recording apparatus of the information B can be used commonly by the recording method and the recording apparatus of the information A.

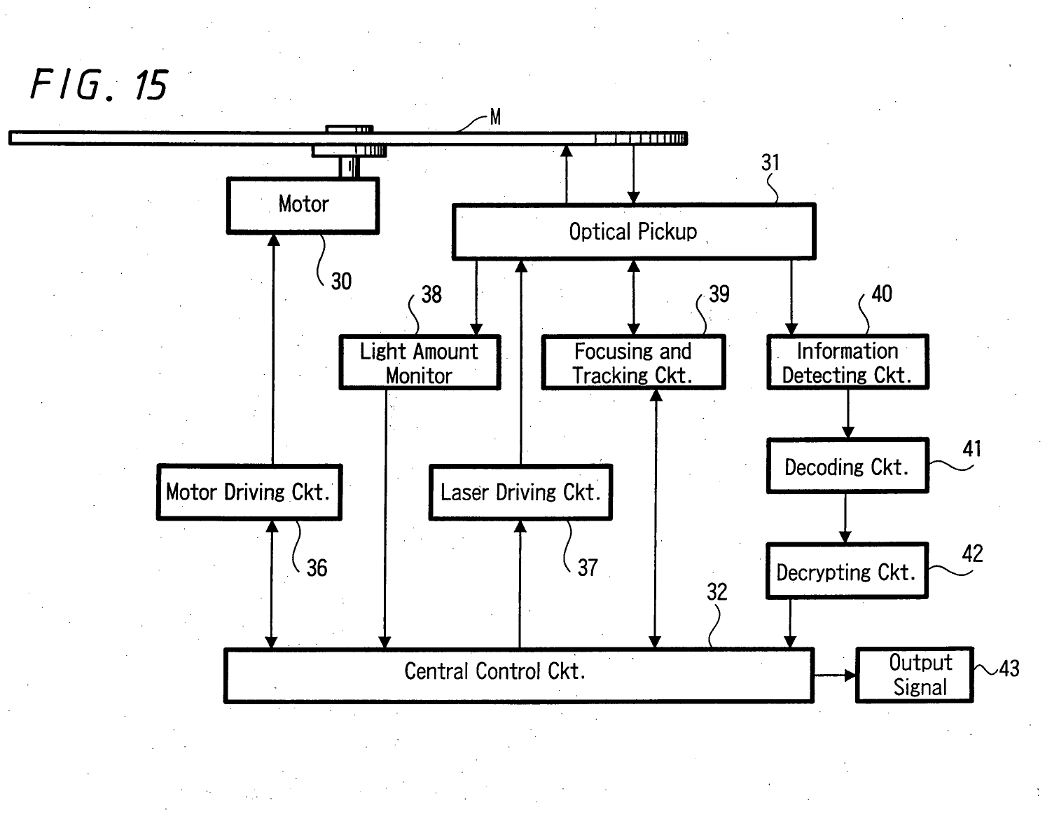

FIG. 15 is a schematic block diagram showing an example of a reproducing apparatus according to the present invention.

In FIG. 15, elements and parts identical to those of FIG. 14 are marked with the identical reference numerals.

First, the information B recorded on the recording medium M is reproduced.

The central control circuit 32 controls the motor driving circuit 36 of the rotary motor 30 for rotating the recording medium M and the laser driving circuit 38 for driving the light source section of the optical pickup 31 of the photo-detecting means so that the above light source section of the optical pickup 31 may generate reproducing laser light.

At the same time, this central control circuit 32 monitors the signal from the light amount monitor 38 which monitors whether information is being reproduced properly by the optical pickup 31 for recording and reproducing the recording medium M, the servo signal from the focusing and tracking monitor 39 which monitors whether information is reproduced from the target position and a signal reproduced from the recording medium M by the optical pickup 31 and controls these signals. An emission intensity and an emission time of laser light obtained at that time are monitored by the light amount monitor 38 and their information are fed back to and managed by the central control circuit 32. The position of target information on the recording medium M is controlled by a servo signal obtained from the focusing and tracking monitor 39.

The change of transmittance or the change of reflectance obtained from the optical pickup 31 is detected by the photodetector of the optical pickup 31 as the change of light amount of passed light of reproduced light or the change of light amount of reflected light and converted into an electrical signal. The reproduced signal is introduced into an information detecting circuit 40, decoded by a decoding circuit 41, decrypted by a decrypting circuit 42 and then inputted to the central control circuit 32. It is determined by the central control circuit 32 whether or not the information thus obtained is proper information. If it is determined by the central control circuit 32 that this information is the proper information, then the information A can be read out from the recording medium M by the optical pickup 31 and reproduced as an output signal 43.

Ordinary reproducing method and reproducing apparatus can be used as reproducing method and reproducing apparatus of the information A and part of or whole of the reproducing apparatus of the above information B can be used commonly.

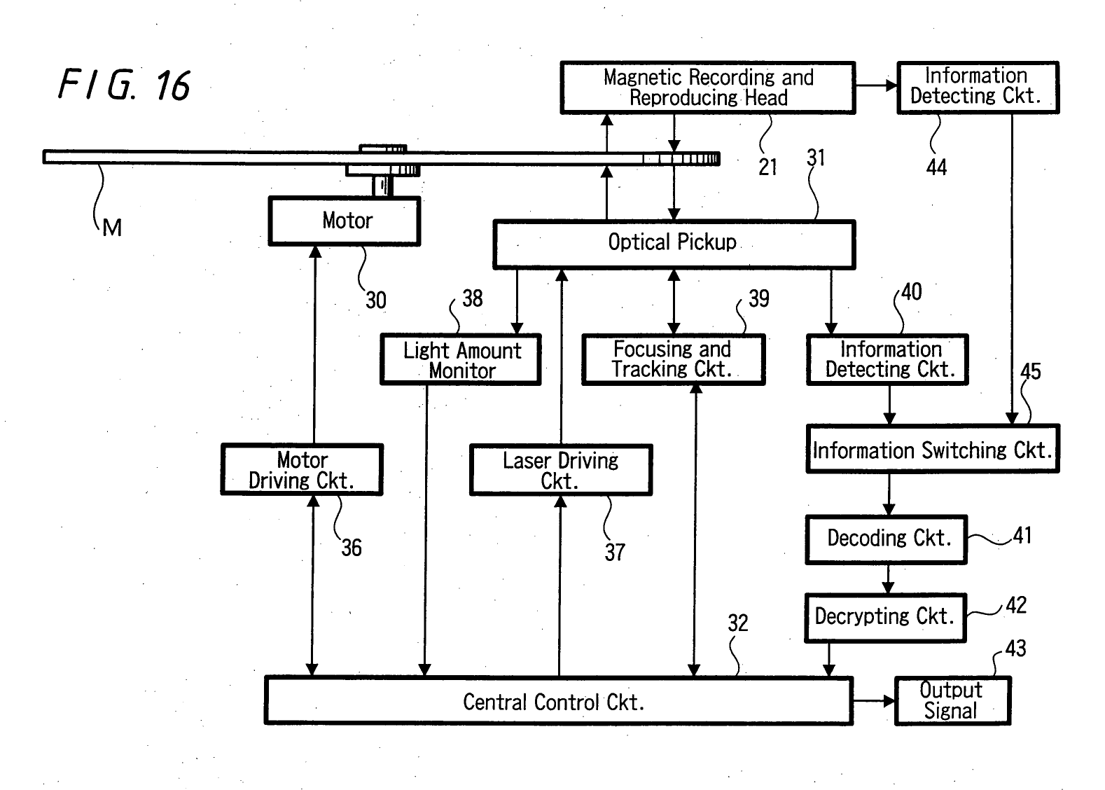

FIG. 16 is a schematic block diagram showing an example of a reproducing apparatus used when the recording medium M in which the recording area 3 of the information A shown in FIGS. 6 and 7 is comprised of a magnetic layer is used.

In FIG. 16, elements and parts identical to those of FIGS. 14 and 15 are marked with the identical reference numerals and therefore need not be described. In this case, there are provided the aforementioned magnetic recording and reproducing head 21 concerning the information A and the optical pickup 31 concerning the information B.

In this recording and reproducing apparatus, the information B is reproduced by a method similar to that of FIG. 15. If it is determined by this reproduction that the recording medium M is a proper recording medium, then the central control circuit 32 supplies a control signal to the magnetic recording and reproducing head 21 such that it may record and reproduce information on the magnetic recording medium. As a result, a magnetic recording signal based on information A is reproduced from the magnetic recording medium by the magnetic recording and reproducing head 21 and information A is detected from the reproduced magnetic recording signal by the information detecting circuit 44. A detected signal is switched by a information switching circuit 45 and introduced into the decoding circuit 39. Then, the decoded signal from the decoding circuit 41 is decrypted by the decrypting circuit 42 and inputted to the central control circuit 32, from which there can be obtained the output signal 43.

When the recorded information B is the aforementioned multi-value recording information, stepwise or continuous multi-value output signal can be obtained as the output signal 43.

While the recording apparatus and the reproducing apparatus are respectively illustrated in the apparatus shown in FIGS. 14 to 16 by way of example, a recording and reproducing apparatus can be constructed by an arrangement having these functions.

In the arrangements shown in FIGS. 15 and 16, for example, there are provided the input circuit system of the input information shown in FIG. 14, i.e., the input apparatus 33, the encrypting circuit 34 and the encoding circuit 35. Moreover, the optical pickup 31 and the magnetic head 21 are provided with both of recording and reproducing functions.

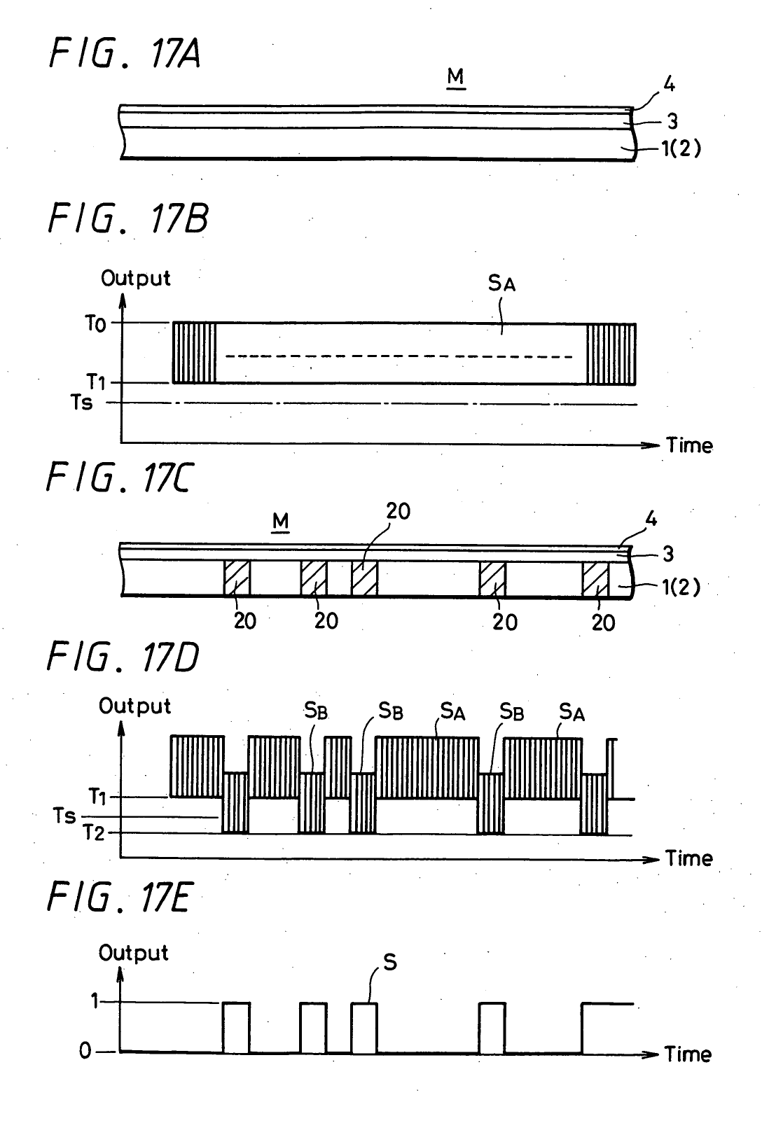

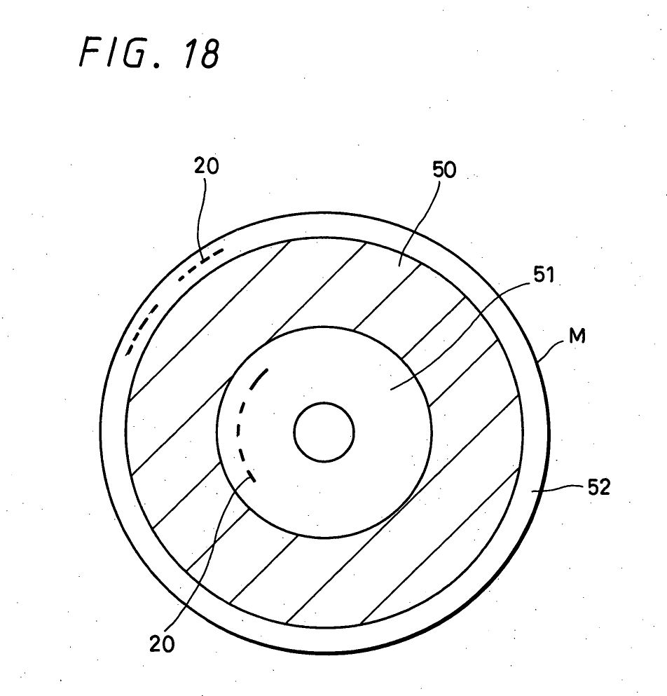

In the above respective apparatus, the signal of the information B can be detected as a binary signal by a binarization processing, for example, which will be described below with reference to FIGS. 17A to 17E.

As shown in FIG. 17A, for example, in the recording medium M in which the aforementioned recording layer 3 of various types is recorded on the light transmission substrate 1 or the light transmission protecting film 2 as the recording area 3 and the reflecting film 4 is formed on the recording layer 3, when the reproduced signal of the information A is a signal S_{A} of levels T₀ to T₁ as shown in FIG. 17B, a recording potion 20 of information B is formed on the light transmission substrate 1 or the light transmission protecting film 2 of the recording medium M. A signal from this recording portion 20 is obtained as a signal S_{B} having level T₂ as shown in FIG. 17D. Accordingly, when this signal is binarized based on the slice level of level Tₛ, shown by a dot-and-dash line in FIGS. 17B and 17D, between levels T₁ and T₂, there can be detected information B as shown in FIG. 17E.

Although the information A and the information B can be recorded on the recording medium M at positions in which they are overlapping with each other in response to their recording and reproducing methods, when information is recorded with irradiation of ultraviolet rays having the same wavelength, for example, the information B is recorded on the recording medium M at position in which it may not overlap with the information A. For example, as shown in a plan view of FIG. 18, in the disk-like recording medium M, the recording portion 20 of the information A is formed in an inner peripheral area 51 or an outer peripheral area 52 except a recording range 50 in which the information A is formed.

Alternatively, as mentioned before, the information A can be recorded on one of the land and groove and the information B can be recorded on the other.

The recording wavelength λra and the reproducing wavelength λpa of the information A should preferably be realized by a light source section having wavelengths in the visible light region. When this light source section is comprised of a semiconductor laser and the like, the recording and reproducing apparatus can be made compact in size.

The recording wavelength λra and the reproducing wavelength λpa of the information A can be realized by an infrared semiconductor laser having a wavelength 830 nm, red semiconductor lasers having wavelength 780 nm, 680 nm, 650 nm and 635 nm, a green semiconductor laser having a wavelength of about 532 nm and a blue semiconductor laser having a wavelength of about 400 nm. To be concrete, the light source section should preferably be comprised of a semiconductor laser having a wavelength longer than 300 nm and shorter than 900 nm.

The recording wavelength λrb and the reproducing wavelength λpb of the information B should preferably be generated from a light source section having wavelength in the ultraviolet light region. When this light source section is comprised of a suitable means such as a solid-state laser and a semiconductor laser, the recording and reproducing apparatus can be made compact in size. Accordingly, the recording wavelength λrb and the reproducing wavelength λpb of the information B can be realized by a blue semiconductor laser having a wavelength of about 400 nm, a far-ultraviolet solid-state laser made of a nonlinear optical crystal having a wavelength 266 nm, excimer lamps having wavelength 108 nm, 126 nm, 146 nm, 154 nm, 161 nm, 172 nm, 253 nm, 291 nm, 351 nm, a KrF excimer laser having a wavelength 248 nm, an ArF excimer laser having a wavelength 193 nm and an F2 excimer laser having a wavelength 157 nm. To be concrete, the recording wavelength λrb and the reproducing wavelength λpb of the information B should preferably be generated from a light source section having a wavelength longer than 100 nm and shorter than 500 nm.

Next, inventive examples concerning the light transmission substrate 1 comprising the recording medium M according to the present invention will be described. It is needless to say that the present invention is not limited to those inventive examples which will described below.

### INVENTIVE EXAMPLE 1

In this case, there was prepared a light transmission substrate 1 having a diameter of 120 nm made of polycarbonate resin. The thickness of this light transmission substrate 1 maybe selected to such an extent that the change of transmittance or the change of reflectance of this light transmission substrate 1 can be detected. In this case, the thickness of the light transmission substrate 1 was selected to be 0.6 mm.

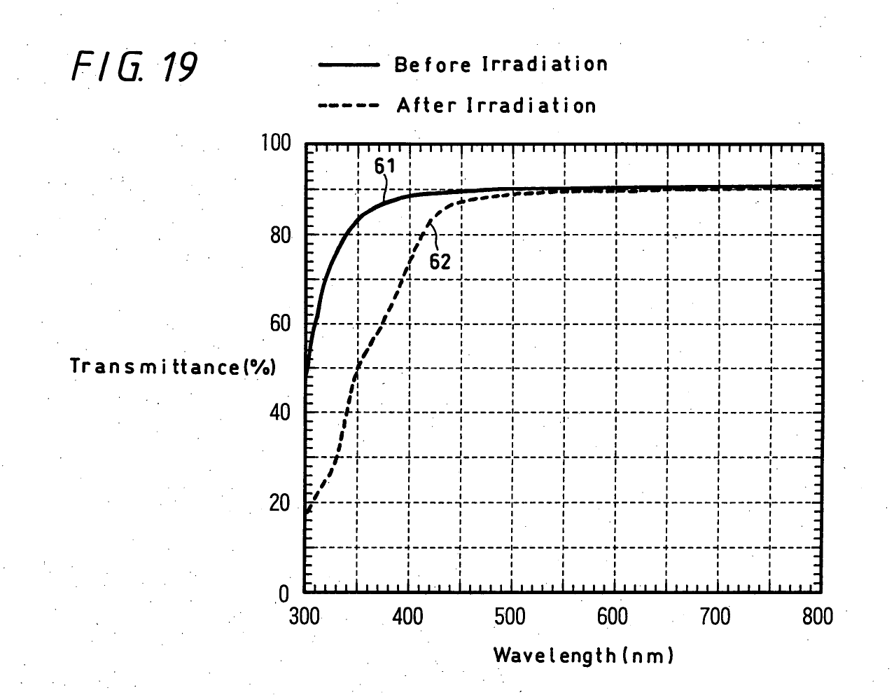

There were measured wavelength dependences of transmittances of a sample in which this light transmission substrate 1 was irradiated with ultraviolet rays 10 minutes by a ultraviolet lamp and a sample obtained before ultraviolet rays are irradiated on the light transmission substrate 1. In FIG. 19, a solid-line curve 61 shows a wavelength dependence of transmittance relative to the sample obtained before the light transmission substrate 1 is irradiated with ultraviolet rays. In FIG. 19, a dashed-line curve 62 shows a wavelength dependence of transmittance relative to the sample obtained after the light transmission substrate 1 was irradiated with ultraviolet rays.

In this case, as the ultraviolet ray irradiating apparatus, there was used a ultraviolet ray irradiating apparatus manufactured by Technovision Corporation under the trade name of “UVO-CLEANER” whose model type was 144A-100. The ultraviolet lamp is a low pressure mercury grid lamp, and its lamp output is 20 mW/cm². Wavelengths of main ultraviolet rays were 184.9 nm and 253.7 nm, respectively. The irradiation was carried out in the atmosphere of nitrogen gas. Transmittance was measured at wavelengths ranging from 300 nm to 800 nm by a spectrophotometer.

A study of FIG. 19 reveals that transmittance is decreased, in particular, transmittance is considerably decreased at wavelength under 500 nm by irradiating ultraviolet rays on the light transmission substrate. Then, transmittance is decreased from 88% obtained before irradiation to 75% obtained after irradiation at a wavelength 400 nm, and is decreased from 84% obtained before irradiation to 50% obtained after irradiation at a wavelength 350 nm, respectively.

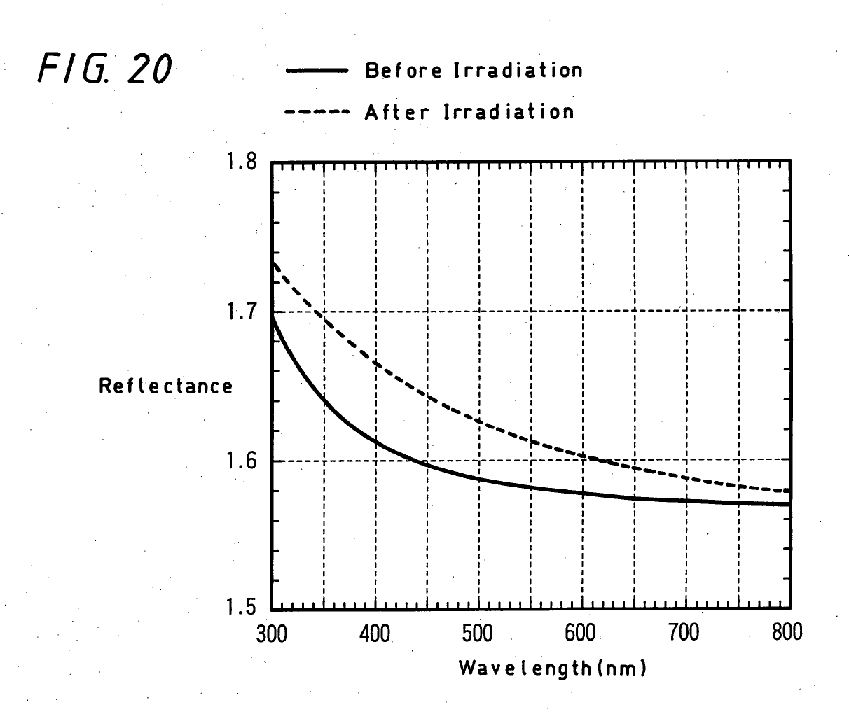

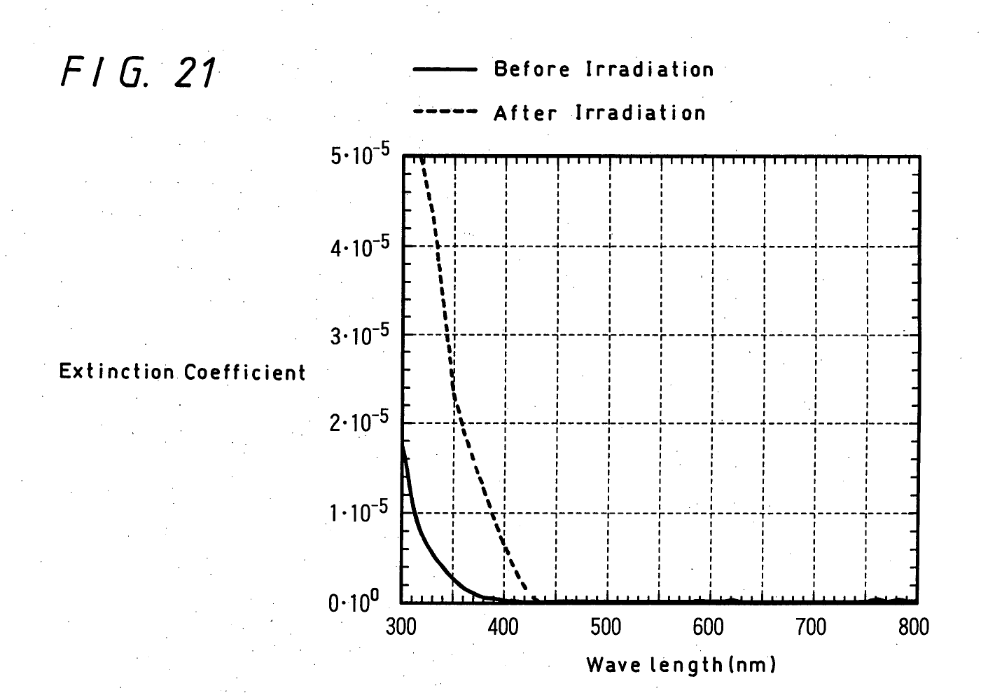

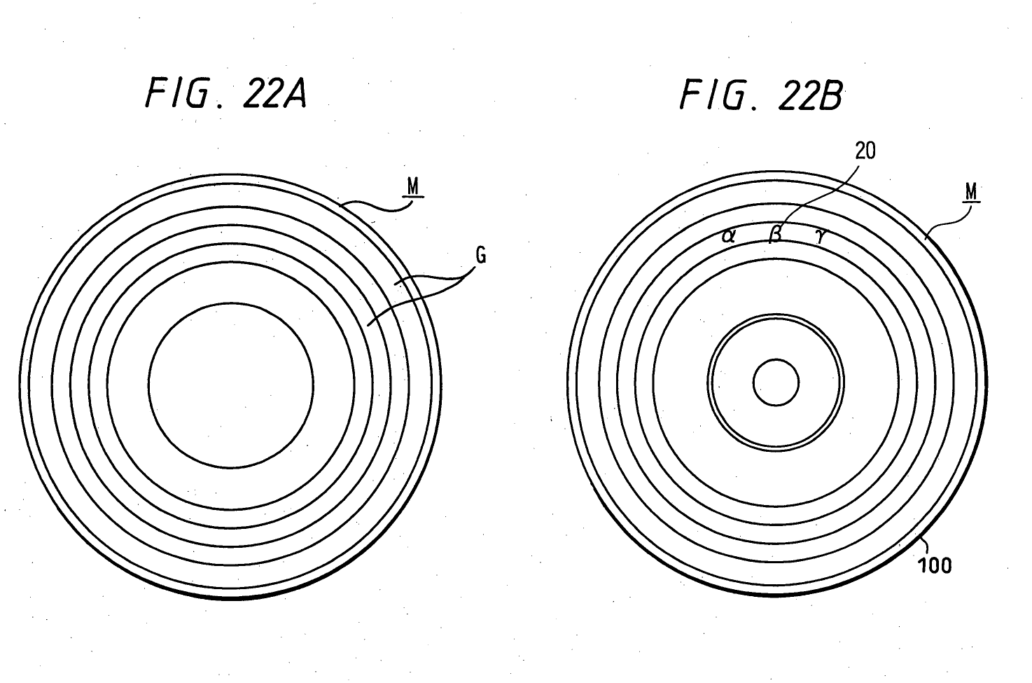

Next, in order to understand a phenomenon in which transmittance is changed with irradiation of ultraviolet rays, the optical constant of this light transmission substrate 1 was measured by an ellipsometry spectrometer. FIG. 20 shows compared results of wavelength dependences of refractive indexes measured before and after irradiation of ultraviolet rays.

FIG. 21 shows compared results of wavelength dependences of extinction coefficients measured before and after irradiation of ultraviolet rays.

As shown in FIGS. 20 and 21, it was confirmed that the refractive index and the extinction coefficient which are the optical constants of the light transmission substrate 1 are changed with irradiation of ultraviolet rays.

It was observed by a stereo optical microscope whether or not the shape of the light transmission substrate 1 was changed before and after irradiation of ultraviolet rays. However, it was confirmed that the shape of the light transmission substrate 1 was not changed at all before and after irradiation of ultraviolet ray. Accordingly, the change of the transmittance is considered as chemical change or alteration occurred within the resin material by irradiation of ultraviolet rays. It should be considered that the change of the transmittance is not the physical change of the shape by so-called laser abrasion such as evaporation and deformation of resin material with irradiation of ultraviolet laser beams as has been so far reported.

Specifically, the change of the optical characteristic (change of transmittance or change of reflectance) due to irradiation of ultraviolet rays are based on the changes of refractive index and extinction coefficient themselves which are the optical constants of the resin material.

As is clear from FIG. 19, when the transmittance or the reflectance changed with irradiation of ultraviolet rays is used, according to the inventive recording medium M, information can be recorded on and reproduced from the light transmission substrate 1.

Specifically, according to the present invention, as described before, while information B can be recorded by the change of transmittance, for example, of the light transmission substrate 1 of the recording medium M with irradiation of ultraviolet rays, the information B can be reproduced by detecting the change of the transmittance of this light transmission substrate 1.

Further, inventive examples in which refractive index and extinction coefficient which are optical constants of the light transmission substrate 1 are changed by irradiating the light transmission substrate 1 with ultraviolet rays, whereby transmittance or reflectance of the light transmission substrate 1 is changed to thereby record and reproduce information B in the form of characters, numerals, image and bar code will be described.

### INVENTIVE EXAMPLE 2

In this case, information was recorded by selectively irradiating the light transmission substrate 1 with ultraviolet rays.

Specifically, in this case, there was used a light transmission substrate made of polycarbonate resin having a diameter of 120 mm with the arrangement in which very small concavities and convexities shown in FIG. 1 were formed. Also in this case, the thickness of the substrate 1 may be selected to an extend that the change of transmittance or the change of reflectance of this substrate 1 can be detected. In this case, the thickness of this substrate 1 was selected to be 0.6 mm.

On this one major surface of this light transmission substrate 1, there were formed grooves comprising four zones whose track pitch ranges from 0.40μ to 0.36 μm at the unit of 0.02 μm.

In actual arrangement, it is needless to say that, in addition to the above grooves, pit marks and wobbled grooves for reading address and the like may be formed on one major surface of this light transmission substrate 1.

In this case, information B based on characters were recorded on the light transmission substrate 1 on which several annular grooves G are formed as shown in FIG. 22A by selectively irradiating ultraviolet rays on the light transmission substrate 1 through a photo-mask with ultraviolet rays as shown in FIG. 22B. Also in this case, ultraviolet rays were irradiated on only the character portions 10 minutes.

In this case, those characters could be observed visually by the naked eyes.

Accordingly, as mentioned before, it is to be understood that numerals, characters, bar codes and images can be written on the recording medium.

While the change of the transmittance based on light passed through the light transmission substrate 1 is detected as described above, the present invention is not limited thereto, and the reflecting film in which aluminum, copper, platinum, silver, gold and alloy thereof having predetermined reflectance were deposited may be formed on the light transmission substrate 1 obtained after irradiation of ultraviolet rays and the change of the transmittance can be detected as the change of amount of reflected light by reflected light from the light transmission substrate 1.

While the information B is recorded on the light transmission substrate 1 on which the grooves G are formed in FIGS. 22A and 22B, the present invention is not limited thereto, and a recording medium can be comprised of the light transmission recording material 100 itself and similar information B can be recorded on this resultant recording medium with similar effects being achieved.

Next, an inventive example in which a refractive index and an extinction coefficient, which are optical constants of the light transmission substrate 1, are changed with irradiating the light transmission substrate 1 with ultraviolet rays, whereby the transmittance or the reflectance of the light transmission substrate 1 is changed to thereby record and reproduce information B will be described.

### INVENTIVE EXAMPLE 3

In this inventive example 3, as earlier noted with reference to the inventive example 2, since information can be recorded on the light transmission substrate 1 by selectively irradiating an arbitrary position of the light transmission substrate 1 with ultraviolet rays, information B was recorded on the light transmission substrate 1 by selectively irradiating the light transmission substrate 1 with ultraviolet rays and the information B thus recorded was reproduced by the reproducing apparatus according to the present invention.

Also in this case, similarly as described before, there was prepared the light transmission substrate 1 having the diameter of 120 mm. Also in this case, while the thickness of this light transmission substrate 1 may be selected to an extent that a change of transmittance or a change of reflectance can be detected, in this case, the thickness of the light transmission substrate 1 was selected to be 0.6 mm.

When ultraviolet rays were irradiated on this light transmission substrate 1, similarly as described before, recording mark trains were recorded as information B by irradiating the light transmission substrate 1 with ultraviolet rays from the ultraviolet ray lamp through the photo-mask. These recording mark trains were recorded while the lengths of the marks were being changed as 2.0 mm, 1.0 mm, 0.5 mm and 0.3 mm, respectively.

In this case, it is needless to say that grooves, pit marks, wobbled grooves for reading address, a reflecting film and a recording layer can be formed on one major surface of the light transmission substrate 1.

In order to reproduce the light transmission substrate 1 in which these information B were recorded by irradiation of ultraviolet rays by the reproducing apparatus according to the present invention next, a reflecting film made of aluminum having a thickness of 100 nm was deposited on one major surface of the light transmission substrate in which information B were recorded by a sputtering apparatus.

Thereafter, a ultraviolet-curing resin was coated on this aluminum reflecting film and cured with irradiation of ultraviolet rays, thereby resulting in a protecting film being formed.

The material of the reflecting film is not limited to aluminum and the reflecting film may be made of other material having proper reflectance at a reproducing wavelength, e.g., aluminum alloy, copper, platinum, silver, gold and alloy thereof.

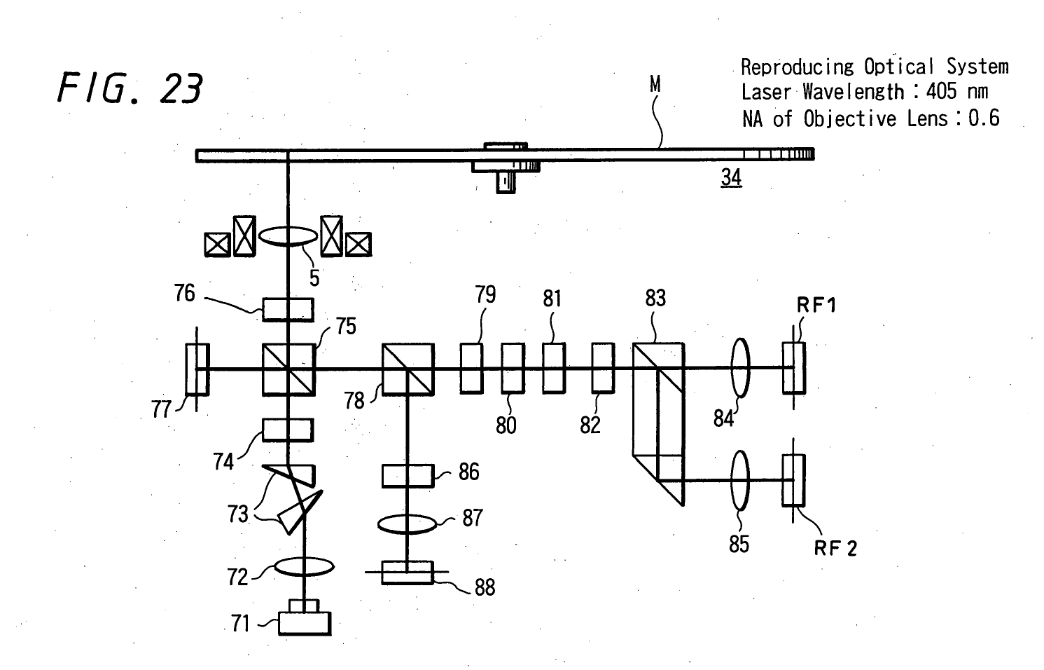

The recording medium M in which the information B was recorded in this manner was reproduced by the inventive reproducing apparatus using an optical pickup 34 shown in FIG. 23.

Alight source 71 for generating reproducing light was a gallium nitride semiconductor laser having a wavelength of 405 nm. There was used the objective lens 5 whose numerical aperture (NA) was 0.6.

A linear velocity of the recording medium M was selected to be 3.46 m/s.

When the information B was detected from the recording medium M, information B was detected as a sum of detected outputs of amounts of reflected lights introduced into detectors RF1 and RF2 from the recording medium M and the detected information was used as a reproduced signal of information B. Power of reproducing laser light used upon reproduction was selected to be 2 mW.

In this example, reproducing laser light from the laser (not shown) having the wavelength of 405 mm in a light source 71 is irradiated on the recording medium M through a collimator lens 72, an anamorphic lens 73, a beam splitter 75, a half-wave plate 76 and the objective lens 5.

A monitor signal for controlling power of the laser 71 is obtained by detecting laser light, partly reflected by the beam splitter 75, with a front monitor detector 77.

Laser light reflected from the recording medium M is introduced into the beam splitter 75 through the objective lens 5 and the half-wave plate 76, thereby reflected and introduced into other beam splitter 78, in which part of introduced light is passed and part of introduced light is reflected. Reflected laser light passed through the beam splitter 78 is introduced into a beam splitter 83 through a half-wave plate 82, thereby splitted into two optical paths and then introduced into the detectors RF1 and RF2 through multi-lenses 84, 85, respectively.

On the other hand, laser light splitted by the beam splitter 78 is introduced into a condenser lens 86, a multi-lens 87 and a focus detector 88.

While the sum of the detected outputs from the detectors RF1 and RF2 can be used as described before, when information A, for example, is recorded on the magneto-optical recording medium, i.e., information A is read out from the magneto-optical recording medium by detecting Kerr rotation angle θk, Kerr rotation angles +θk and −θk are detected and are produced output is detected by a difference between these outputs, thereby increasing the reproduced output.

It is needless to say that the arrangement of the optical system of the reproducing apparatus shown in FIG. 23 can be modified depending upon various reproducing methods of information A. Further, the arrangement of the reproducing optical system of information B is not limited thereto and may be modified so long as it can detect the change of amount of passed light or the change of amount of reflected light.

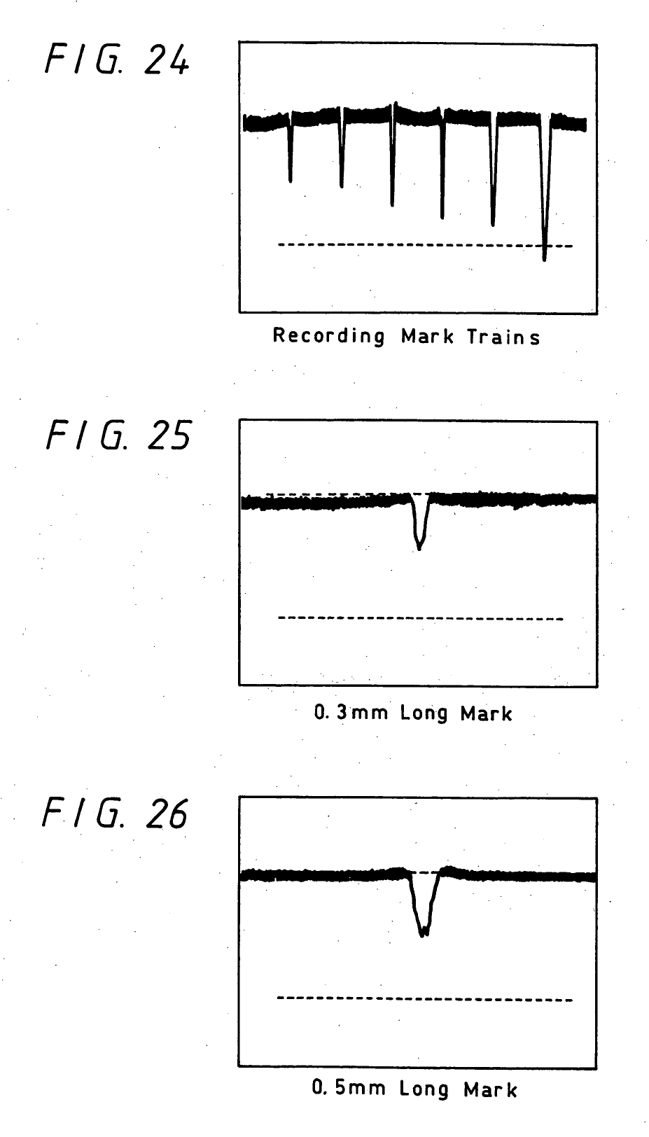

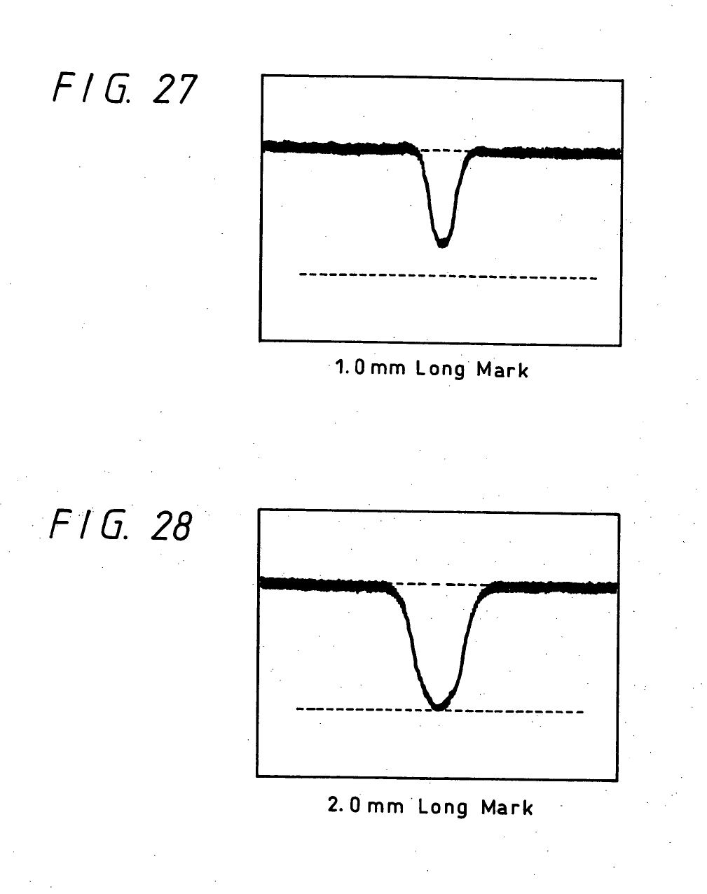

FIGS. 24 to 28 show reproduced signals obtained by detecting the change of amount of reflected light from this recording medium M. FIG. 24 shows recording mark trains and it was confirmed that a stable and satisfactory signal could be obtained. FIGS. 25 to 28 show reproduced signals in which lengths of recording marks are 0.3 mm, 0.5 mm, 1.0 mm and 2.0 mm, respectively.

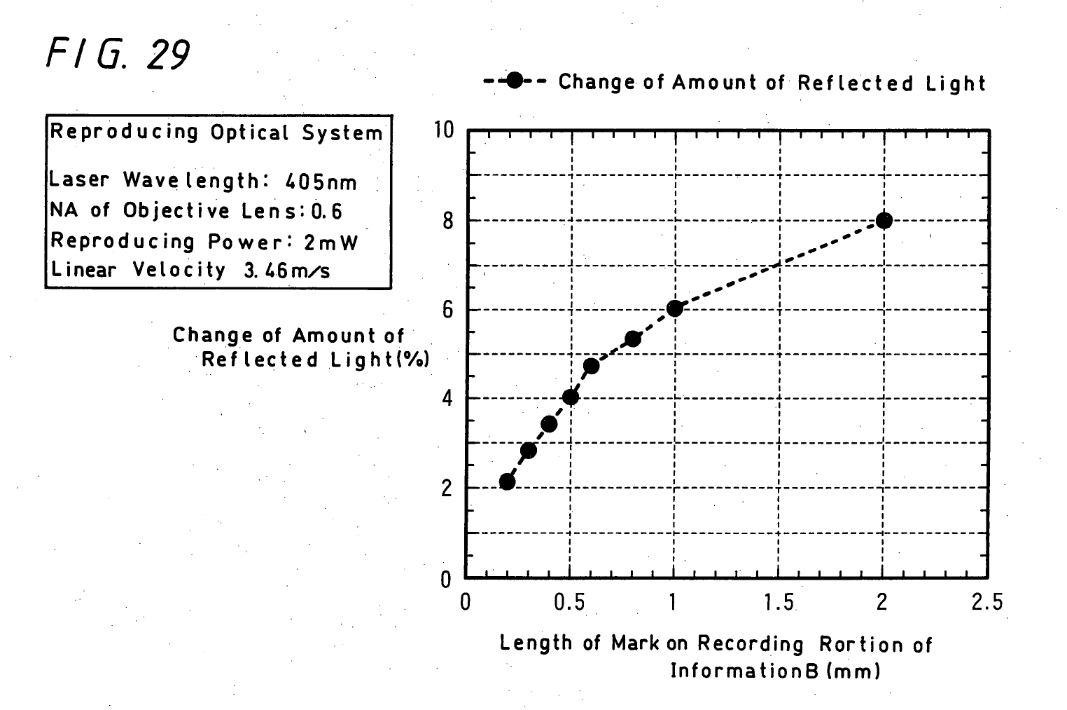

FIG. 29 show ratios in which amount of reflected light is changed relative to lengths of recording marks thus obtained. It was confirmed that any recording marks thus recorded can provide stable and satisfactory signals.

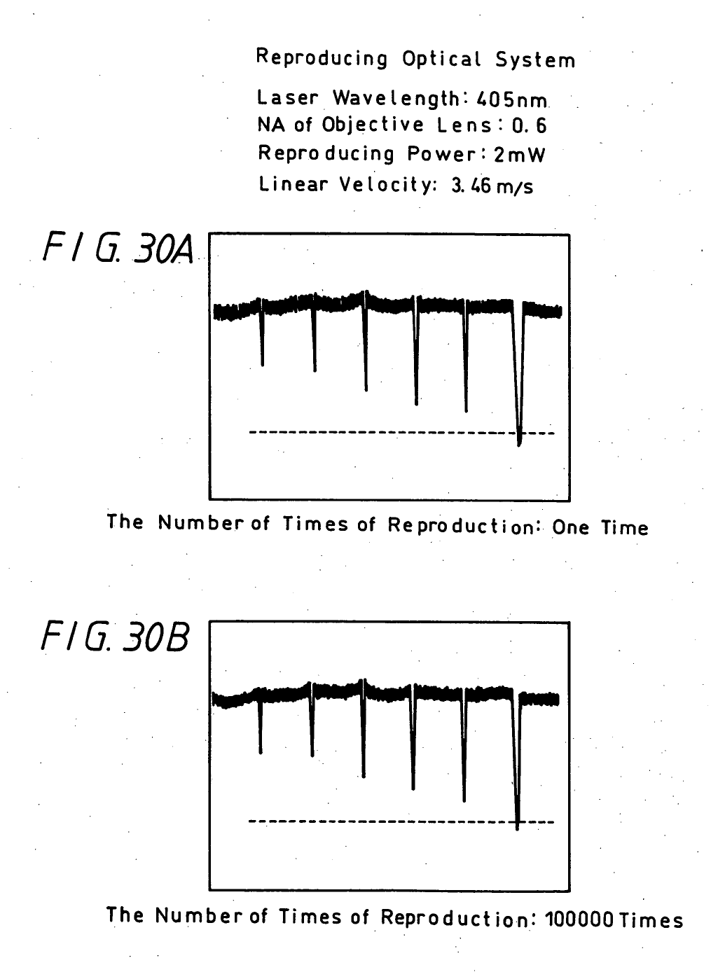

FIGS. 30A and 30B show reproduced signals of recording mark trains obtained when the recording medium is reproduced one time and 100000 time, respectively. As is clear from the comparison of these reproduced signal, the reproduced signal obtained after the recording medium was reproduced 100000 times can provide a stable and satisfactory signal.

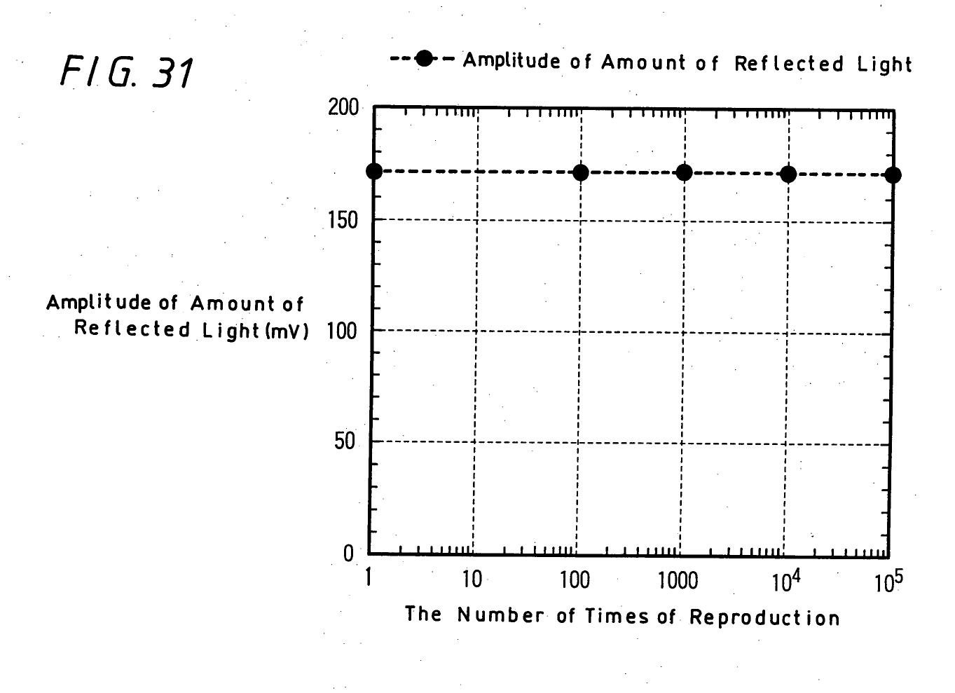

FIG. 31 shows an amplitude of amount of reflected light of 2.0 mm-long mark relative to the number of times of reproduction. As shown in FIG. 31, with respect to the reproduction of 100000 times, the amplitude of the amount of reflected light is not changed at all. Therefore, it was to be understood that information B of the recording medium M according to the present invention is recorded as extremely stable and irreversible information.

In a like manner, the reflecting film made of aluminum was replaced with a pigment recording film such as a phthalocyanine-based pigment film, a magnetic recording film such as a CoPtCr-based magnetic film, a magneto-optical recording film such as a TbFeCo-based magnetic film and a phase change recording film such as a GeSbTe-based film and deposited on one major surface of the light transmission substrate 1 in which information B was recorded by respective deposition apparatus. Then, information B could be reproduced by changing the changes of amount of reflected light with the reproducing apparatus similarly.

In this case, information could be reproduced while no trouble occurs in a reproduction stability until the recording medium is reproduced 100000 times.

In the case of the above recording film, except the recording film, an optical interference film, a heat control film and a reflecting film can properly be added and deposited.

The above arrangement of the magneto-optical recording film was changed to a magnetic super-resolution recording medium such as central detection type magnetic super-resolution recording medium, e.g., a MAMMOS (Magnetic Amplifying Magneto-Optical System) and a magnetic domain enlarged reproducing medium such as a DWDD (Domain Wall Displacement Detection) which includes at least a reproducing layer and a recording layer and in which an information magnetic domain recorded on a recording layer is selectively transferred to the reproducing layer by using a temperature distribution within reproducing light or a magnetic domain is enlarged and transferred to the reproducing layer upon reproduction and then deposited on the light transmission substrate 1 in which information B was recorded by respective deposition apparatus. Then, information B could be reproduced by changing the changes of amount of reflected light with the reproducing apparatus similarly.

In this case, information could be reproduced while no trouble occurs in a reproduction stability until the recording medium is reproduced 100000 times.

In the case of the above recording film, except the recording film, an optical interference film, a heat control film and a reflecting film can properly be added and deposited.

Therefore, it became clear that, according to the present invention, the information B can be reproduced from the light transmission substrate M extremely satisfactorily and stably by the reproducing method of the present invention and that recorded information is irreversible and stable.

Therefore, it was confirmed that the recording medium M, the recording and reproducing method and the recording and reproducing apparatus according to the present invention are very suitable for recording information such as inherent identification information of recording medium which should preferably be prevented from being easily rewritten.

As described above, it was demonstrated that information can be recorded on and reproduced from the light transmission substrate 1 by using the transmittance changed with irradiation of ultraviolet rays according to the recording medium, the recording and reproducing method and the recording and reproducing apparatus of the present invention. Specifically, it was made clear that information can be recorded by the change of the transmittance of the light transmission substrate of the recording medium owing to irradiation of ultraviolet rays and that information can be reproduced by detecting the change of transmittance (or the change of reflectance) of this light transmission substrate.

Specifically, the above inventive example 1 reveals that the refractive index and the extinction coefficient, which are the optical constants of the light transmission substrate 1, are changed by irradiating the arbitrary position of the light transmission substrate 1 with ultraviolet rays, whereby the transmittance of the light transmission substrate 1 is changed to thereby make it possible to record/reproduce information.

The inventive example 2 reveals that information can be recorded on the recording medium by selectively irradiating the arbitrary position of the light transmission substrate 1 with ultraviolet rays.

Further, the inventive example 3 reveals that information can be recorded on the light transmission substrate by selectively irradiating the arbitrary position of the light transmission substrate 1 with ultraviolet rays and that the information thus recorded can be reproduced by using the reproducing apparatus according to the present invention.

Next, an inventive example in which the ultraviolet ray light source is replaced with a ultraviolet lamp and information can be recorded and reproduced by using a ultraviolet ray laser.

### INVENTIVE EXAMPLE 4

Also in this example, there was prepared the light transmission substrate 1 made of polycarbonate resin having the diameter of 120 mm. While the thickness of this light transmission substrate 1 may be selected to an extent that the change of transmittance or the change of reflectance of this light transmission substrate 1 can be detected, in this case, the thickness of this light transmission substrate 1 was selected to be 0.6 mm.

When ultraviolet ray laser light was irradiated on the light transmission substrate 1, ultraviolet ray laser light was irradiated on one major surface of the light transmission substrate 1 by the method that has been described so fat with reference to FIG. 10. A length of a mark of recorded information was selected to be 0.45 mm.

In this case, very small concavities and convexities based on grooves, pit marks and wobbled guide grooves for reading address were formed on one major surface of the light transmission substrate 1. Further, a reflecting film and a recording film also can be recorded on the one major surface of the light transmission substrate 1.

As the used ultraviolet ray laser, there was used a far-ultraviolet sold-state laser manufactured by Sony Precision Technology Corporation under the trade name of UW-1020.

The wavelength of generated ultraviolet ray light was 266.0 nm and a diameter of its beam spot was 0.8±0.2 mm. The irradiation of ultraviolet ray laser light was executed in the atmosphere. In this case, ultraviolet ray laser light was directly introduced into the light transmission substrate 1 and information was recorded under control of the on and off of irradiation and an irradiation time executed by a mechanical shutter disposed at a laser emitting outlet.

In order to reproduce the light transmission substrate 1 in which these information were recorded by irradiation of ultraviolet rays by the reproducing apparatus according to the present invention next, a reflecting film made of aluminum having a thickness of 100 nm was deposited on one major surface of the light transmission substrate in which information were recorded by a sputtering apparatus.

Thereafter, a ultraviolet-curing resin was coated on this aluminum reflecting film and cured with irradiation of ultraviolet rays, thereby resulting in a protecting film being formed.

In this case, the material of the reflecting film is not limited to aluminum and the reflecting film may be made of other material having proper reflectance at a reproducing wavelength, e.g., aluminum alloy, copper, platinum, silver, gold and alloy thereof.

The recording medium M in which the information was recorded in this manner was reproduced by the inventive reproducing apparatus using an optical pickup, i.e., a reproducing apparatus according to the present invention. A reproducing laser was a gallium nitride semiconductor laser having a wavelength of 405 nm. There was used the objective lens whose numerical aperture (NA) was 0.6. A linear velocity of the recording medium was selected to be 3.46 m/s.

When the information was detected from the recording medium, information was detected as a sum of detected outputs of amounts of reflected lights introduced into detectors RF1 and RF2 from the recording medium M and the detected information was used as a reproduced signal of information B. Power of reproducing laser light used upon reproduction was selected to be 2 mW.

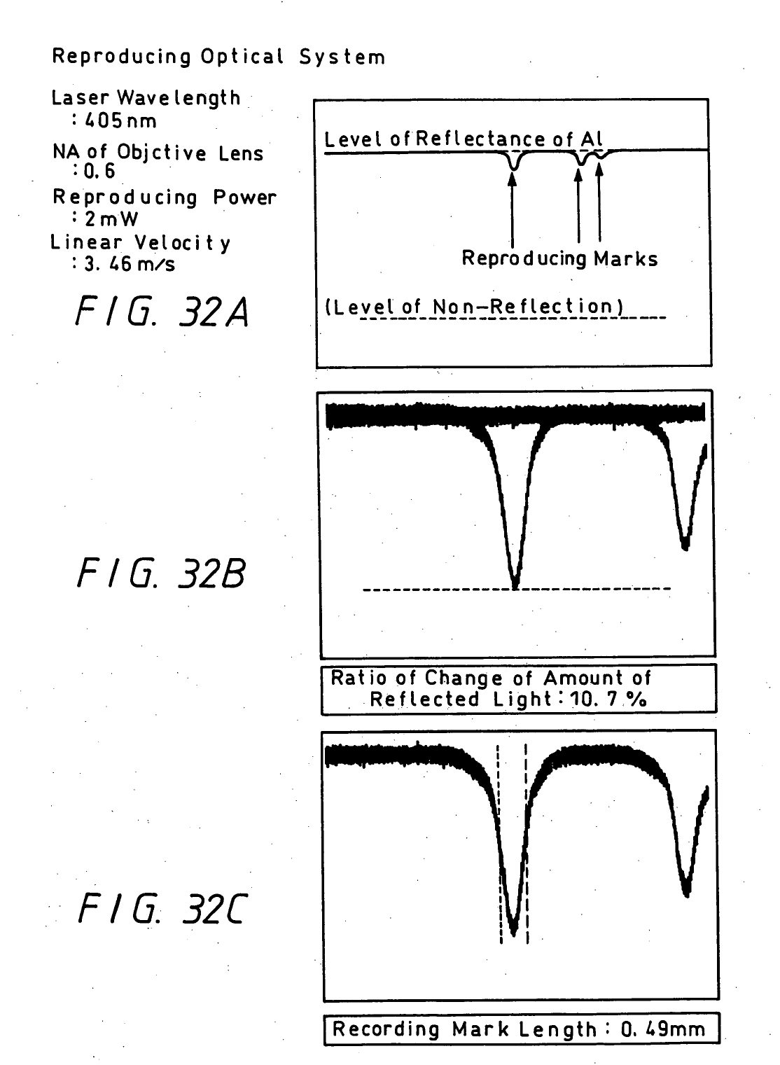

FIGS. 32A to 32C show measured results of reproduced signals obtained by detecting the change of amount of reflected light from this recording medium. As shown by arrows in FIG. 32A and as shown in FIGS. 32B and 32C in an enlarged-scale, the reflected light amount is changed with the irradiation time of ultraviolet rays and a recording signal can be modulated by a time or an intensity of ultraviolet ray irradiation. It was confirmed that the signal thus obtained can provide a stable and satisfactory signal.

With respect to the reproduction of 100000 times, the amplitude of the amount of reflected light is not changed at all. Therefore, it was to be understood that information of the recording medium is recorded as extremely stable and irreversible information.

In a like manner, the reflecting film made of aluminum was replaced with a pigment recording film such as a phthalocyanine-based pigment film, a magnetic recording film such as a CoPtCr-based magnetic film, a magneto-optical recording film such as a TbFeCo-based magnetic film and a phase change recording film such as a GeSbTe-based film and deposited on one major surface of the light transmission substrate 1 in which information B was recorded by respective deposition apparatus. Then, information B could be reproduced by detecting the changes of amount of reflected light with the reproducing apparatus similarly.

In this case, information could be reproduced while no trouble occurs in a reproduction stability until the recording medium is reproduced 100000 times.

In the case of the above recording film, except the recording film, an optical interference film, a heat control film and a reflecting film can properly be added and deposited.

The above arrangement of the magneto-optical recording film was changed to a magnetic super-resolution recording medium such as central detection type magnetic super-resolution recording medium, e.g., a NAMMOS and a magnetic domain enlarged reproducing medium such as a DWDD is deposited on the light transmission substrate 1 in which information B was recorded by respective deposition apparatus. Then, information B could be reproduced by detecting the changes of amount of reflected light with the reproducing apparatus similarly.

In this case, information could be reproduced while no trouble occurs in a reproduction stability until the recording medium is reproduced 100000 times.

Also in this case, except the recording film, an optical interference film, a heat control film and a reflecting film can properly be added and deposited.

Therefore, according to the irradiation of ultraviolet ray laser, the information can be reproduced from the light transmission substrate 1 extremely satisfactorily and stably recorded information is irreversible and stable.

Therefore, the recording medium and the recording and reproducing method are very suitable for recording information such as inherent identification information of recording medium which should preferably be prevented from being easily rewritten.

From the above examination, it was demonstrated that information can be recorded on and reproduced from the light transmission substrate by using the transmittance or the reflectance changed with irradiation of ultraviolet rays according to the recording medium, the recording and reproducing method and the recording and reproducing apparatus of the present invention. Specifically, it was proved that information can be recorded by the change of the transmittance or the reflectance of the light transmission substrate of the recording medium owing to irradiation of ultraviolet rays and that information can be reproduced by detecting the change of transmittance or the change of reflectance of this light transmission substrate.

### INVENTIVE EXAMPLE 5

Information is recorded by irradiation of ultraviolet rays, whereby information was recorded in a multi-value recording fashion by the changed amount of arbitrary transmittance.

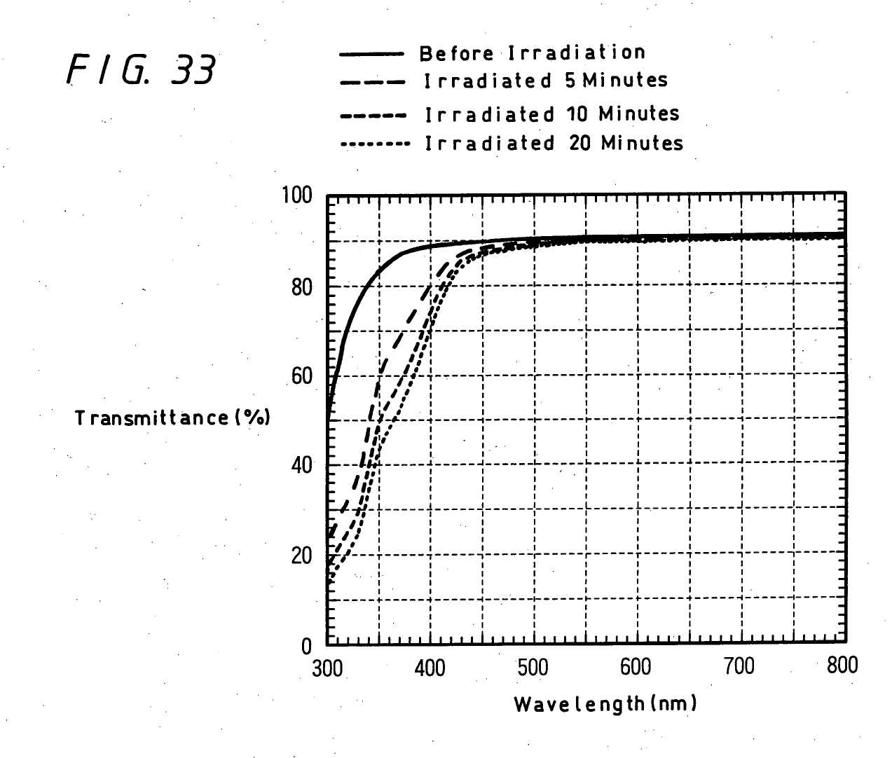

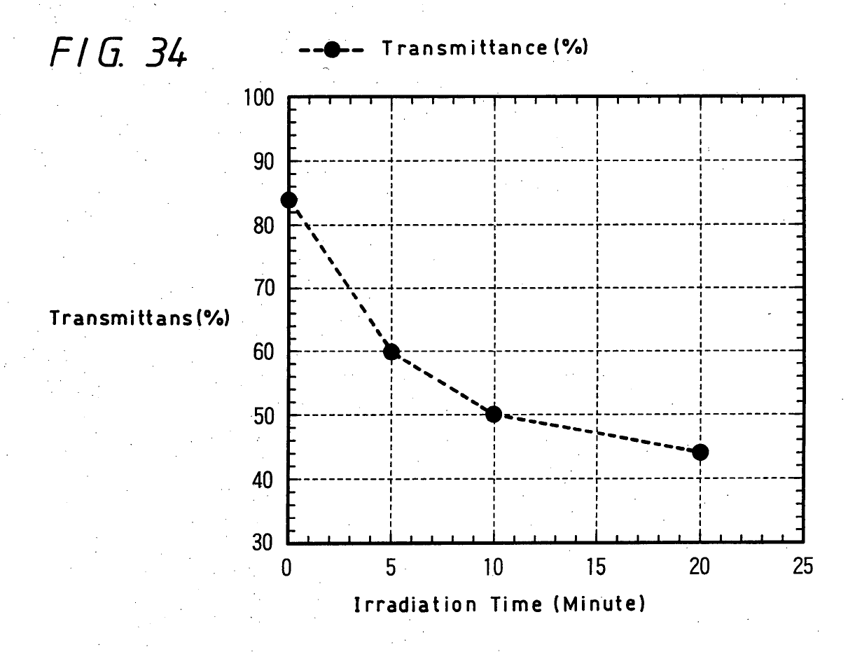

Also in this case, there was used the light transmission substrate 1 similar to that of the inventive example and the like. FIG. 33 show a wavelength dependence of transmittance of a light transmission substrate 1 which was not irradiated with ultraviolet rays and wavelength dependences of transmittances of respective light transmission substrates 1 which were irradiated with ultraviolet rays 5 minutes, 10 minutes and 20 minutes.

FIG. 34 shows a relationship between the transmittance of the light transmission substrate 1 and the ultraviolet ray irradiation time based on the above measured value. A study of FIG. 34 reveals that the transmittance of the light transmission substrate 1 is changed with the irradiation time of ultraviolet rays. For example, it was measured that, at a wavelength of 350 nm, transmittance was decreased to 84% without irradiation of ultraviolet rays, the transmittance was decreased to 60% with irradiation of ultraviolet rays for 5 minutes, transmittance was decreased to 50% with irradiation of ultraviolet rays for 10 minutes and transmittance was decreased to 44% with irradiation of ultraviolet rays for 20 minutes, respectively.

Accordingly, it is to be understood that the changed amount of the transmittance of the light transmission substrate 1 can be arbitrary adjusted by the irradiation time and that information is recorded in a multi-value recording fashion.

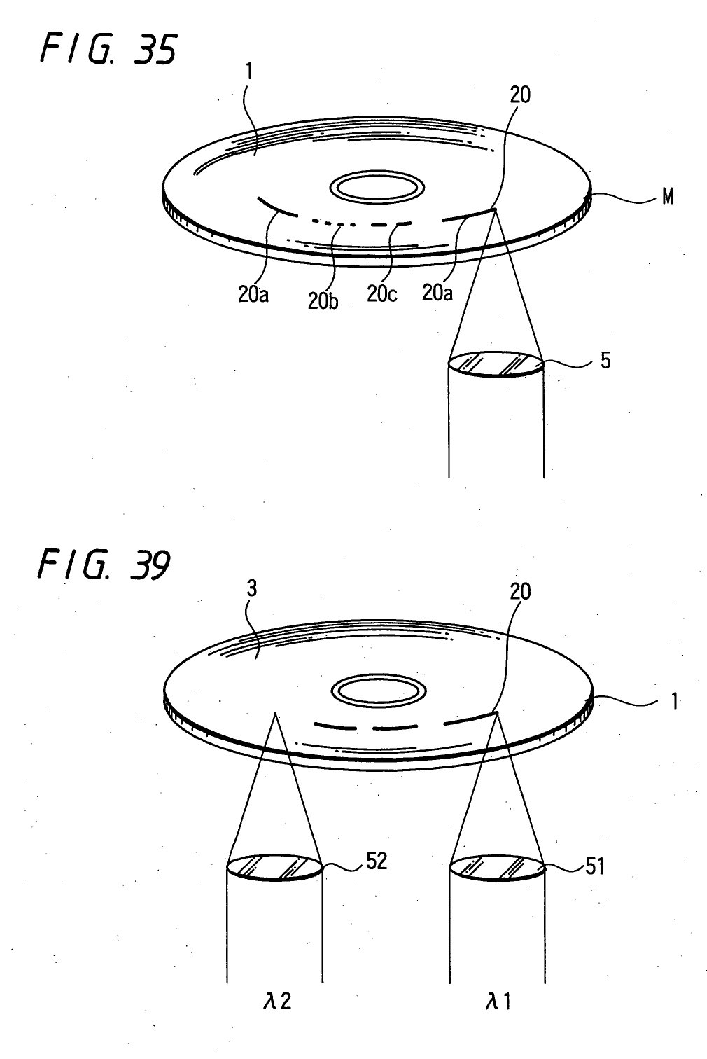

FIG. 35 shows the case in which multi-value recording trains are formed on the light transmission substrate 1 based on recording portions 20a, 20b, 20c of information B whose transmittance is changed by light amount of irradiated ultraviolet rays or/and time for irradiating ultraviolet rays. In this case, not only information can be provided by the mark length of the recording portion but also information can be given to the changed amount of transmittance of recording portion. Accordingly, information can be made high in density.

In this case, while the changed amount of arbitrary transmittance is adjusted by the irradiation time of ultraviolet rays, the changed amount of transmittance can be similarly controlled by intensity of irradiation of ultraviolet rays.

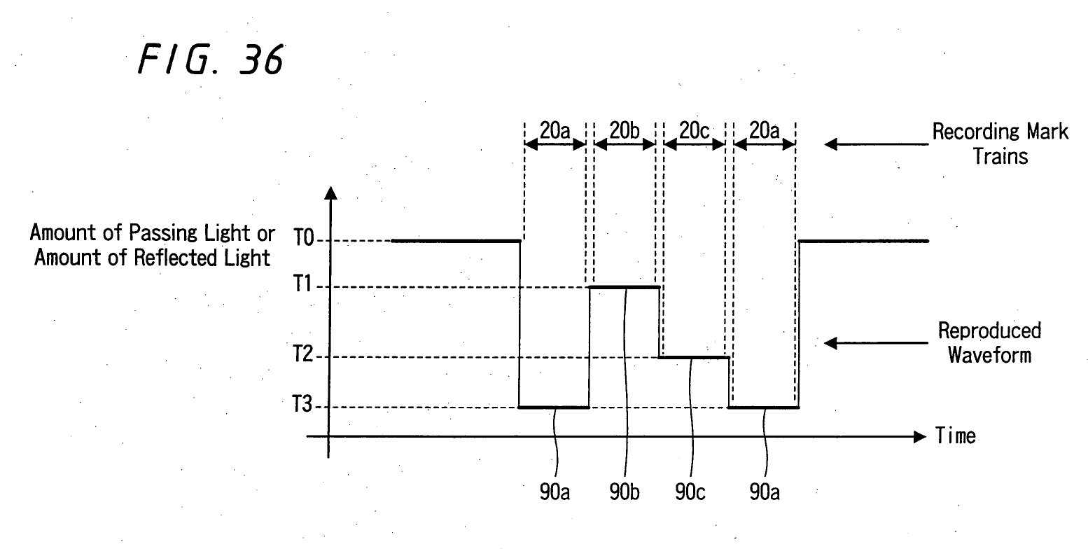

FIG. 36 shows detected signals obtained from the recording portions 20a, 20b, 20c by the above change of the transmittance. As shown in FIG. 36, corresponding multi-value signals 90a, 90b, 90c can be obtained from the above recording portions 20a, 20b, 20c.

### INVENTIVE EXAMPLE 6

With respect to recording of information on the light transmission substrate by irradiation of ultraviolet rays, irreversibility and durability of change of transmittance were confirmed. Also in this case, there was used a similar light transmission substrate 1 similar to that of the aforementioned inventive example 1.

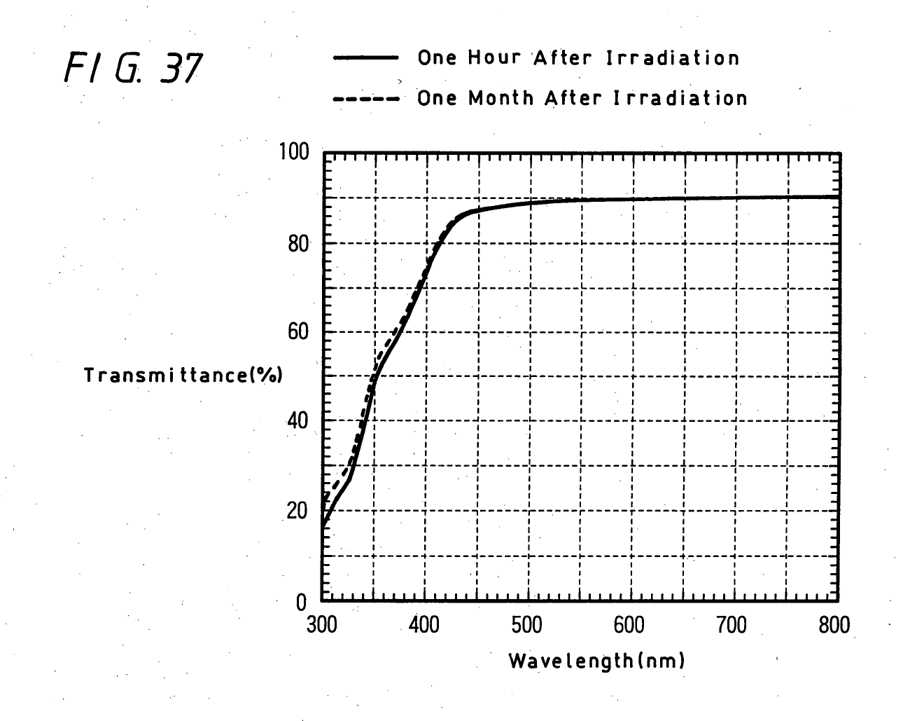

FIG. 37 shows measured results of transmittance of the light transmission substrate 1 which was left at a room temperature one hour in the atmosphere after this light transmission substrate 1 had been irradiated with ultraviolet rays 10 minutes and transmittance of the light transmission substrate 1 which had been left one month.

According to the above measured results, it was confirmed that the change of the transmittance of the light transmission substrate 1 was stable and irreversible even when the light transmission substrate 1 has been left for a long time immediately after irradiation of ultraviolet rays.

Therefore, it was to be understood that the recording medium and the recording method for recording information on the light transmission substrate 1 according to the present invention can be carried out irreversibly and stably and that the recording medium and the recording method according to the present invention are very suitable for recording information B such as inherent identification information of recording medium which should preferably be prevented from being easily rewritten.

### INVENTIVE EXAMPLE 7

Next, with respect to recording of information on the light transmission substrate 1 by irradiation of ultraviolet rays, it was confirmed that information is reproduced at an arbitrary wavelength by using the wavelength dependence of the change of the transmittance.

Also in this case, there was used the same light transmission substrate 1 as that of the inventive example 1.

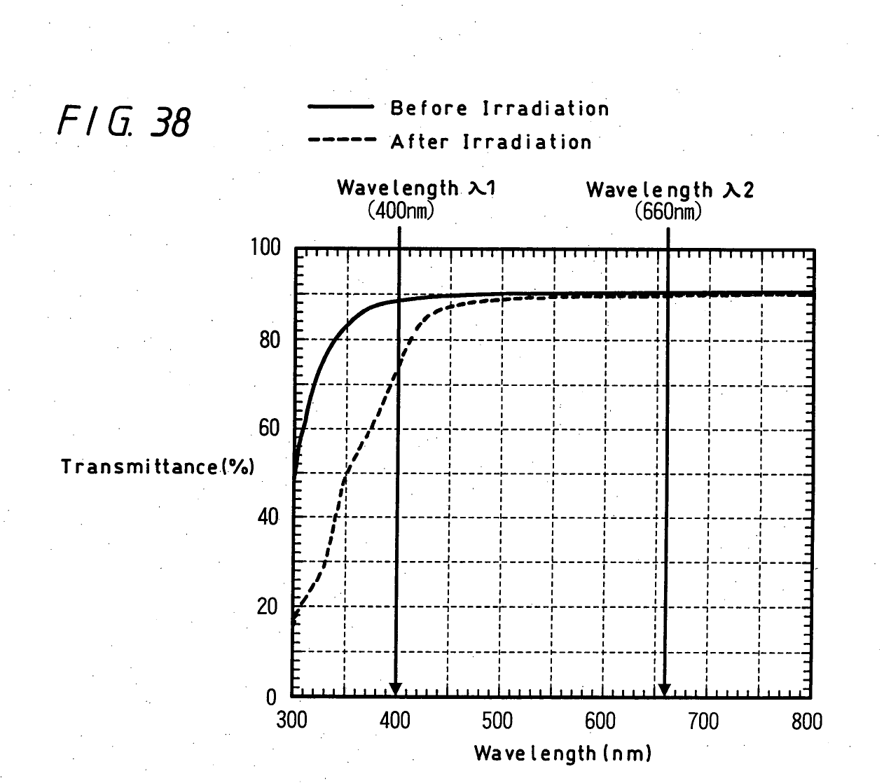

FIG. 38 shows measured results of wavelength dependence of transmittance of the light transmission substrate 1 which is not irradiated with ultraviolet rays and wavelength dependence of transmittance of the light transmission substrate 1 which has been irradiated with ultraviolet rays 10 minutes. As shown in FIG. 38, the transmittance changes from 88% to 74% at a wavelength of 400 nm, and the transmittance is not changed and is held at 90% at a wavelength of 660 nm before and after irradiation of ultraviolet rays.

Accordingly, as schematically shown in FIG. 39, according to the wavelength dependence of this transmittance, while a blue laser having a wavelength of about 400 nm can detect the change of transmittance and therefore can reproduce information, a red laser having a wavelength of 660 nm cannot detect the change of transmittance, when a recording and reproducing apparatus is such one for reproducing the information A by the ordinary red laser, there can be realized a recording and reproducing apparatus in which the information B cannot be reproduced from the light transmission substrate 1.

Then, the recording medium that had been used in the inventive example 3 was reproduced by two reproducing apparatus having two different wavelengths λ₁ and λ₂.

In this case, the respective reproducing optical systems have the arrangements in which the light source wavelength λ₁=660 nm and the numerical aperture of the objective lens is 0.6 (referred to as a “reproducing apparatus 1”) and the light source wavelength λ₂=405 nm and the numerical aperture of the objective lens is 0.6 (referred to as a “reproducing apparatus 2”).

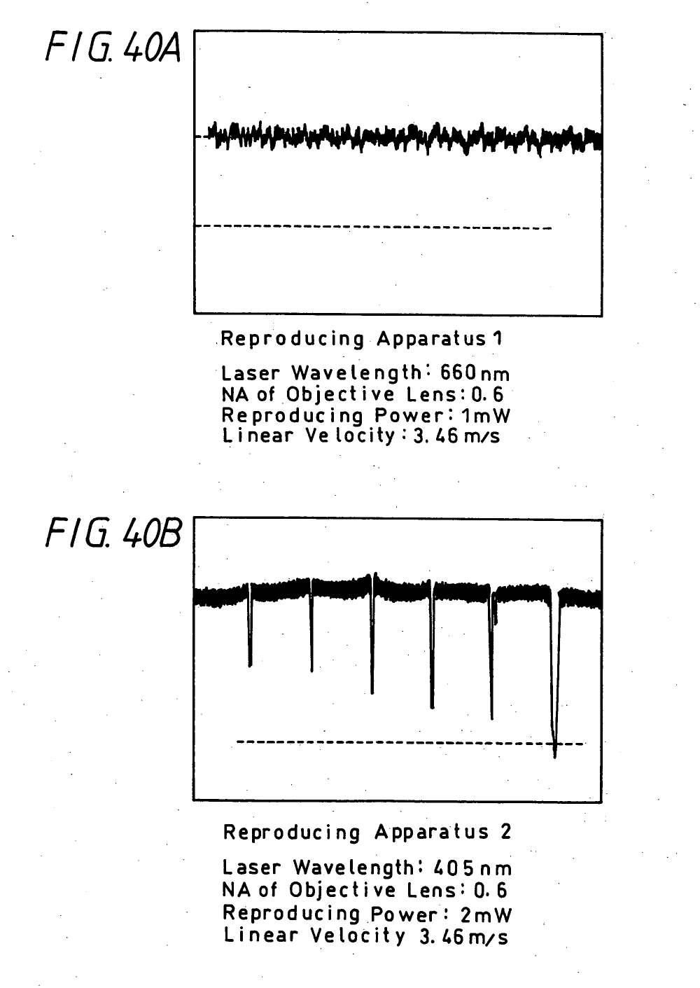

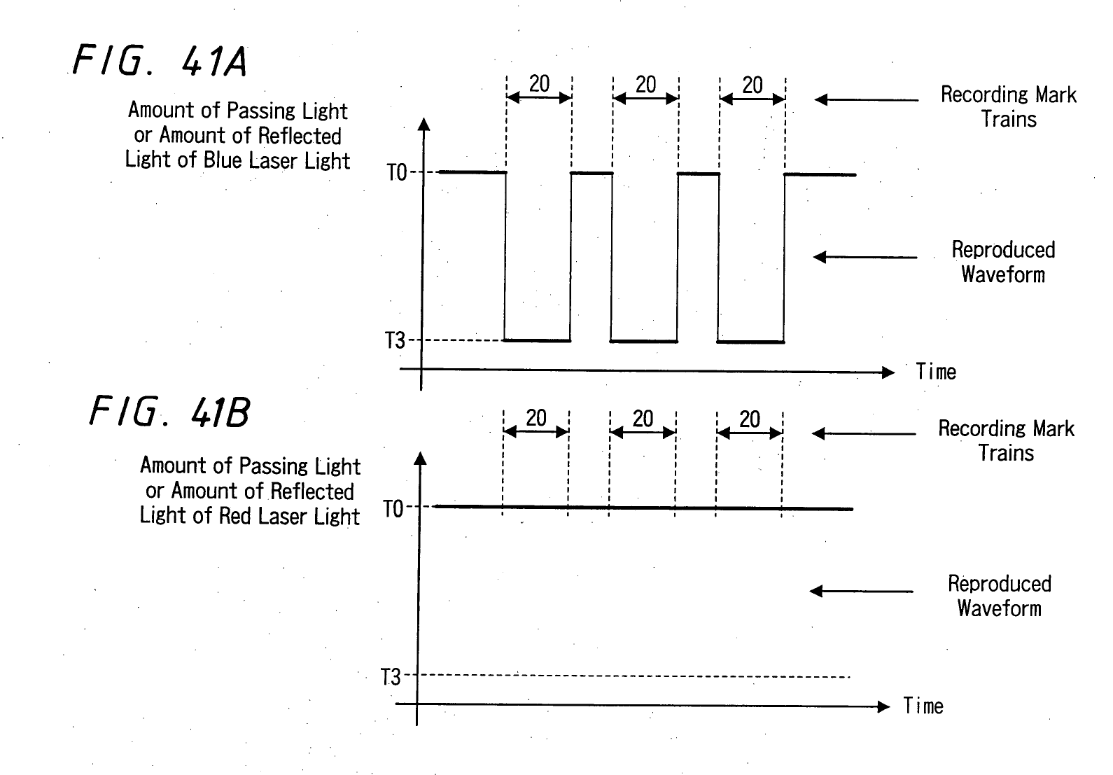

FIGS. 40A and 40B show reproduced signals obtained when the recording medium M in the inventive example 3 was reproduced by the reproducing apparatus 1 and 2, respectively. As shown in FIG. 40A, while a signal cannot be reproduced from the recording portion 20 of the information B by the reproducing apparatus 1 having the laser wavelength of 660 nm, the reproducing apparatus 2 having the wavelength of 405 nm can satisfactorily reproduce the recording portion 20. Specifically, this uses the wavelength dependence of the change of the transmittance of recording information of the recording medium according to the present invention.

Specifically, according to the recording medium M of the present invention, the information B can selectively be reproduced from the light transmission substrate 1 of the recording medium M based on the wavelength of reproducing laser light. To be concrete, as shown in FIG. 41A, when a blue laser is used for the recording portion 20 of the information A, there can be obtained a reproducing waveform signal whose passed light amount or reflected light amount changes from T₀ to T₃. However, as shown in FIG. 41B, according to the reproducing apparatus 1 for reproducing the recording area of the information A by a red blue laser, there cannot be obtained the reproducing waveform for the recording portion 20 of the information B. That is, it becomes possible to record the information B which cannot be reproduced at all without blue laser.

Accordingly, for example, the information B such as identification information inherent in the recording medium M can be stored in the recording medium M under the condition in which the information B cannot easily be recorded and reproduced by users in general.

While the wavelength λ₁ is 660 nm and the wavelength λ₂ is 405 nm as described above, the present invention is not limited thereto and other arrangements maybe used. That is, according to the recording medium and the recording and reproducing method of the present invention, in addition to the information usually recorded on the recording medium, i.e., the information A, the information B recorded on the light transmission substrate 1 as the change of transmittance or the change of reflectance can selectively be reproduced by a reproducing apparatus having a plurality of wavelengths.

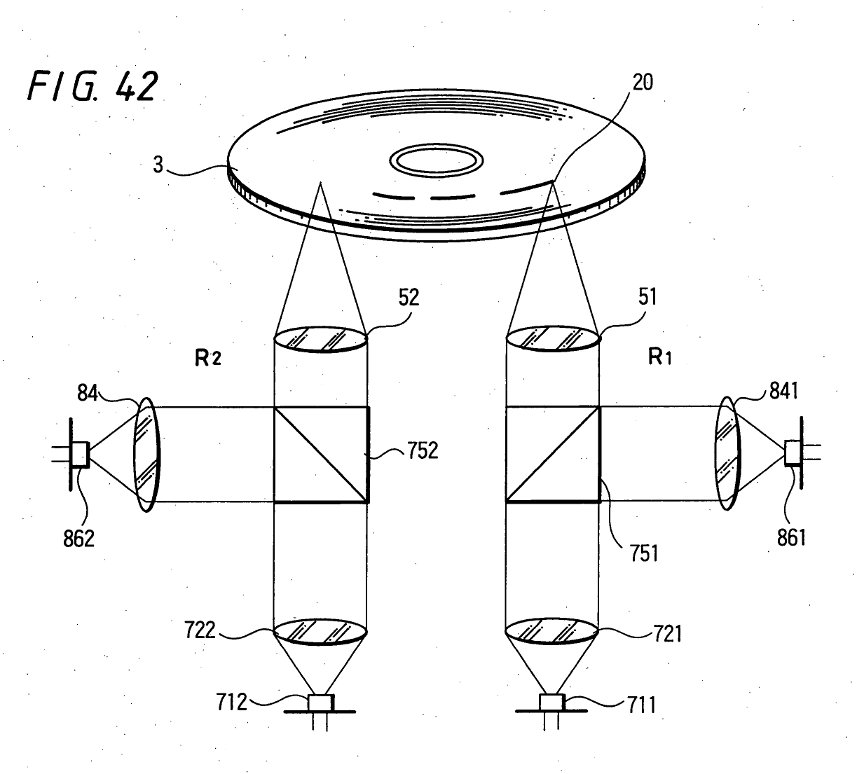

As a reproducing apparatus having a plurality of wavelength, there can be used an arrangement in which reproducing optical systems R₁ and R₂ are respectively provided for the wavelengths λ₁ and λ₂ as shown in a schematic diagram of FIG. 42, for example. As shown in FIG. 42, the two reproducing optical systems R₁ and R₂ include light sources 711, 712 for generating laser beams having wavelength λ₁ and λ₂ and accompanying typical optical elements, i.e., collimator lenses 721, 722, beam splitters 751, 752, objective lenses 51, 52, condenser lenses 841, 842 and photodetectors 861, 862.

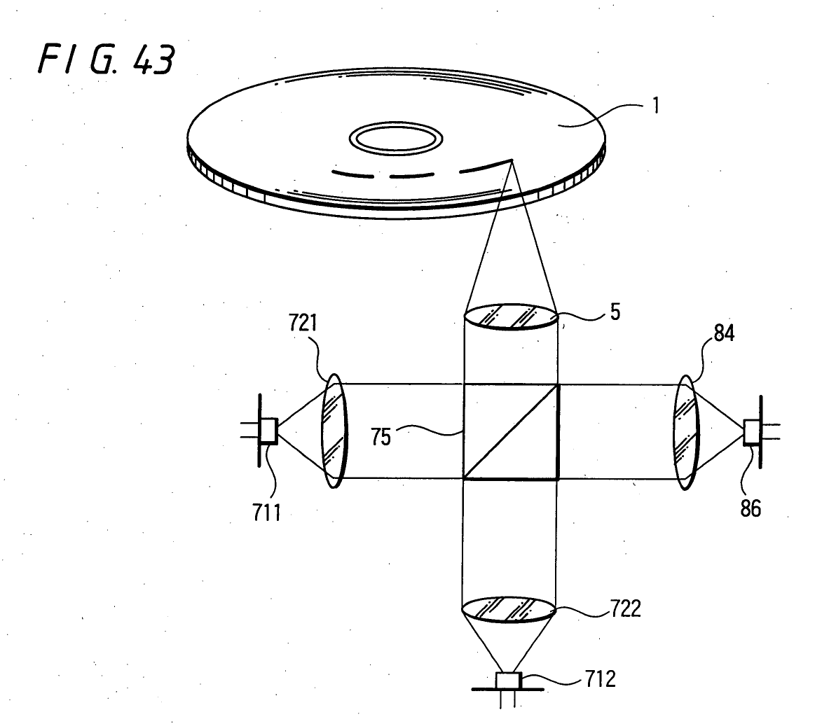

While the reproducing apparatus having a plurality of wavelength is comprised of the two independent reproducing optical systems R₁ and R₂ in the example shown in FIG. 42, the present invention is not limited thereto, and the following variant is also possible. That is, as shown in FIG. 43, part of optical path, i.e., part of optical system, in the illustrated example, there are provided a common beam splitter 75 and a common objective lens 5 so that a photodetector 86 can detect only reproducing light of the information A, i.e., the wavelength λ₁.

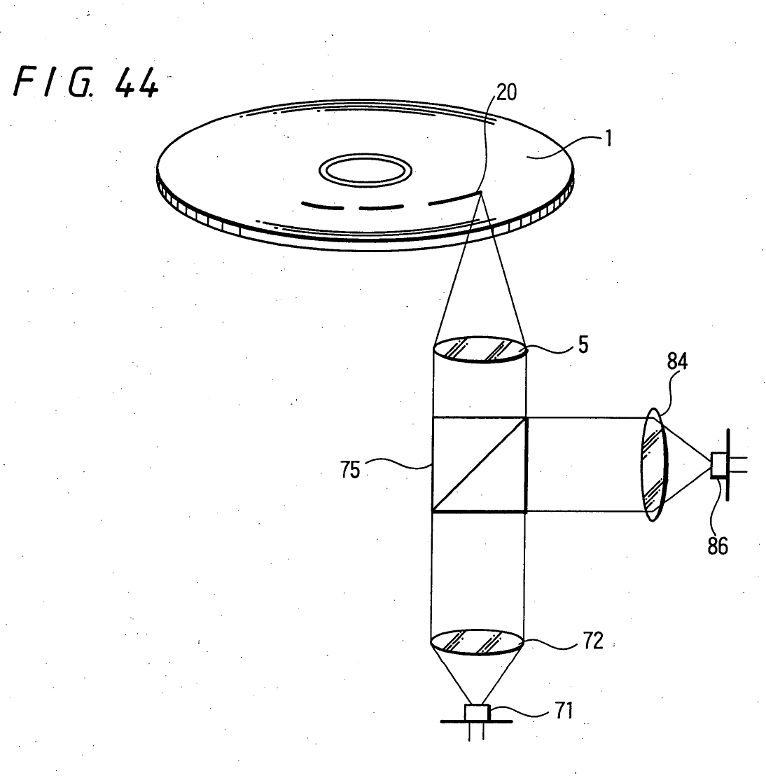

FIG. 44 shows a reproducing method using a light source 71 for generating light having wavelengths containing the two wavelengths λ₁ and λ₂. In FIG. 44, elements and parts identical to those of FIG. 43 are marked with identical reference numerals and therefore need not be described.

The recording and reproducing apparatus can change not only the reproducing optical system but also the optical system, the detection method and the detector in response to the kinds of the information A and the information B, for example.

### INVENTIVE EXAMPLE 8

The light transmission substrate 1 was made of polyolefin resin. Also in this case, while the light transmission substrate 1 has the diameter of 120 nm and the thickness of 0.6 mm, the thickness of this light transmission substrate 1 can freely be changed to an extent that the change of transmittance or the-change of reflectance can be detected.

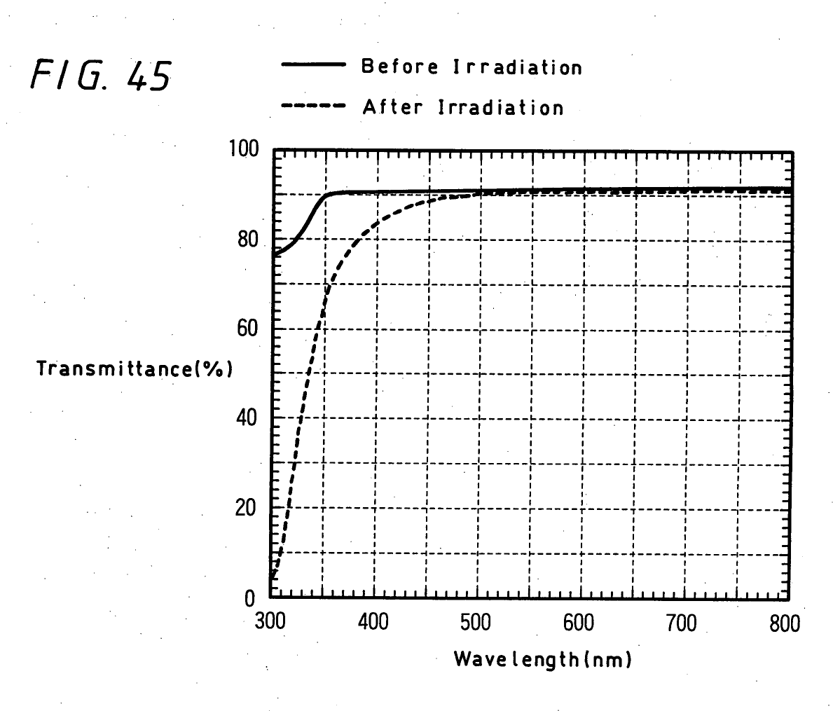

FIG. 45 shows measured results of wavelength dependences of transmittance of a substrate in which ultraviolet rays are irradiated on this light transmission substrate 1 10 minutes and a substrate in which ultraviolet rays are not irradiated on the light transmission substrate 1.

Also in this case, a study of FIG. 45 reveals that, similarly to the polycarbonate material, the transmittance is decreased by irradiation of ultraviolet rays, in particular, the transmittance is considerably decreased at a wavelength less than 500 nm. While the decreased amount is 91% at a wavelength of 400 nm before irradiation of ultraviolet rays, the decreased amount is decreased to 84% after irradiation of ultraviolet rays. While the decreased amount is 90% at a wavelength of 350 nm before irradiation of ultraviolet rays, the decreased amount is decreased to 67% after irradiation of ultraviolet rays.

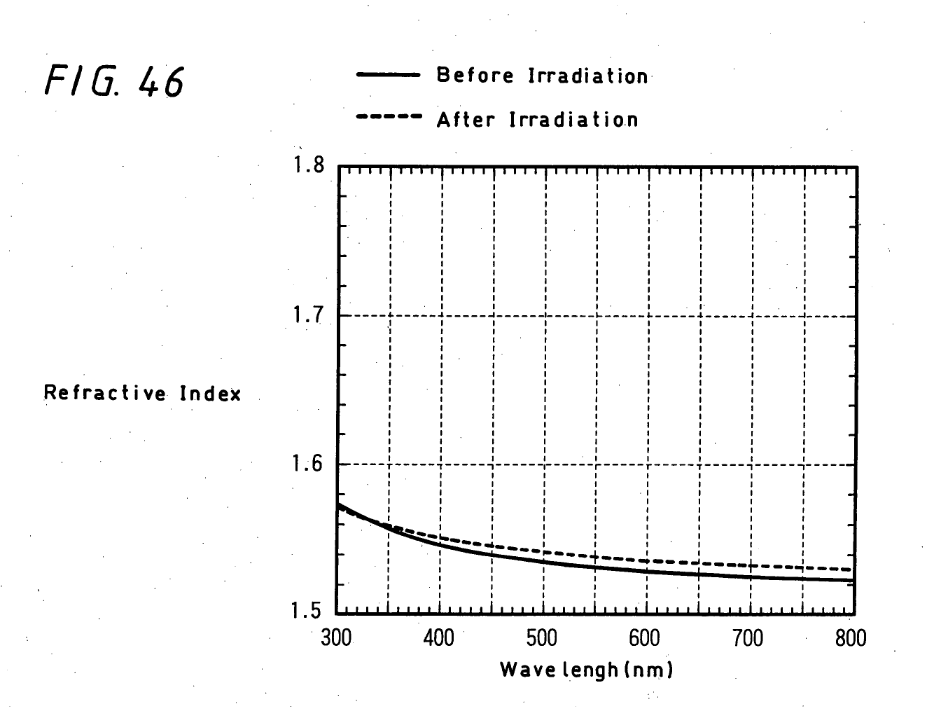

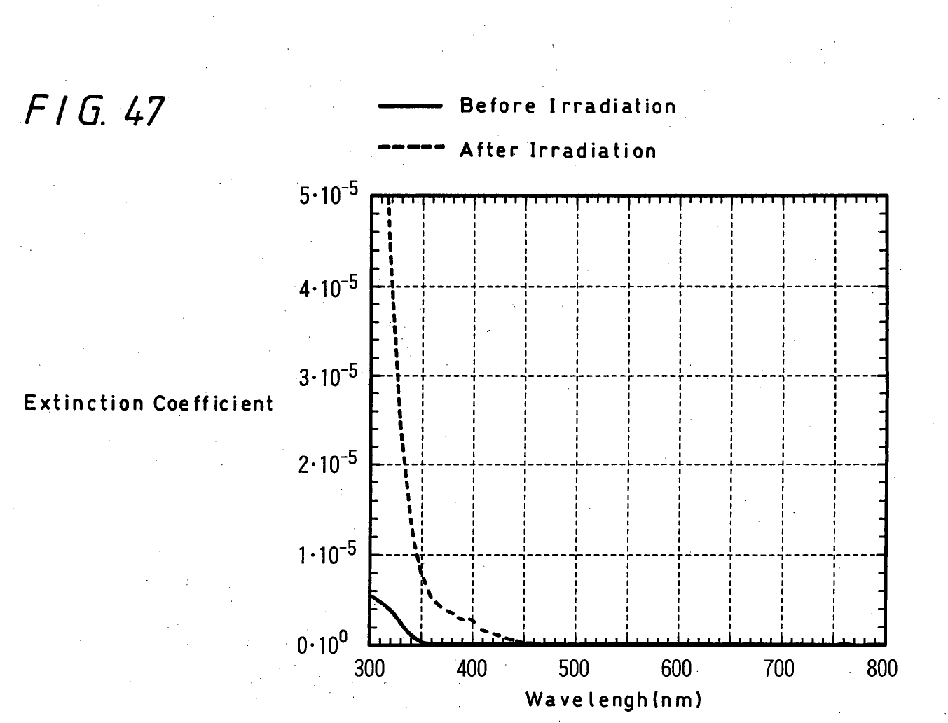

Next, in order to understand the phenomenon in which the transmittance is changed with irradiation of ultraviolet rays, the optical constants of this light transmission substrate 1 were measured by ellipsometry spectrometer. FIG. 46 shows compared results of refractive indexes obtained before and after the light transmission substrate 1 is irradiated with ultraviolet rays. FIG. 47 shows compared results of extinction coefficients obtained before and after the light transmission substrate 1 is irradiated with ultraviolet rays.

As shown in FIGS. 46 and 47, it was confirmed that the refractive index and the extinction coefficient themselves which are the optical constants of the polyolefin material are changed with irradiation of ultraviolet rays similarly to the polycarbonate material.

Accordingly, the change of the transmittance can be considered as the chemical change and alteration caused within the resin material by ultraviolet rays but this change is not the physical change of shapes, caused by so-called laser abrasion, such as evaporation and deformation of resin material with irradiation of ultraviolet laser beams, which point should receive a remarkable attention.

As described above, also in the light transmission substrate 1 made of polyolefin material, the information B can be recorded on and reproduced from the substrate 1 by using the change of optical characteristic (change of transmittance or change of reflectance) and the changes of the refractive index and the extinction coefficient. Accordingly, in the same way as in the above light transmission substrate 1 made of the polycarbonate resin, the information B can be recorded and further the change of the reflectance or the change of the transmittance can be detected. Also in this case, it becomes possible to record and reproduce information.

When the light transmission substrate 1 is made of other material than polycarbonate resin and polyolefin resin, such as polymethyl methacrylate (PMMA) resin, epoxy resin, acrylic resin and glass which are used in an optical disk or the like, it becomes possible to record the information B by irradiation of ultraviolet rays, for example.

While the information B is recorded and reproduced from the light transmission substrate 1 as described above, the information B can similarly be recorded and reproduced from the light transmission protecting film 2 in which, in addition to the materials that can be carried out in the above light transmission substrate 1, a solution-like material is deposited on the substrate 1, for example, cured with ultraviolet rays, for example, to make the light transmission protecting film 2.

Specifically, the light transmission protecting film 2 is made of material such as polycarbonate resin, polyolefin resin, PMMMA resin, epoxy resin, acrylic resin, glass, ultraviolet-curing resin, thermosetting resin and photo-polymer, and the information B can be recorded on and reproduced from the light transmission protecting film 2.

As described above, according to the present invention, there is provided the recording medium including the recording area of the information A in which this information A can be recorded and reproduced. Identification information inherent in the recording medium M or recording information can be recorded/reproduced as the information B by using the change of the transmittance of the light transmission substrate 1 of the recording medium M or the change of the reflectance. As a result, there can be realized the recording medium which can hardly be duplicated, imitated and forged, its recording and reproducing method and its recording and reproducing apparatus.

Similarly, the recording medium according to the present invention is the recording medium including the recording area of the information A in which the information A is recorded and reproduced. Identification information inherent in the recording medium M or recording information can be recorded/reproduced as the information B by using information of the change of transmittance of the light transmission protecting film 2 of the recording medium or the change of the reflectance. As a result, there can be realized the recording medium which can hardly be duplicated, imitated and forged, its recording and reproducing method and its recording and reproducing apparatus.

While the disk mediums have been mainly illustrated and described so far in the above inventive examples and the embodiments, the present invention is not limited to the disk medium and the recording medium of the present invention can take various shapes and arrangements such as a card-like recording medium.

While optical recording has been described so far in the above examples, information can be recorded on the light transmission recording material, the light transmission substrate and the light transmission protecting film with irradiation of electron beams by using the electron beam irradiating apparatus.

As set forth above, according to the recording medium, the recording and reproducing method and the recording and reproducing apparatus of the present invention, the information B can be recorded on and reproduced from the light transmission substrate 1 by using the transmittance changed with or the reflectance changed with irradiation of ultraviolet rays. Specifically, the transmittance or the reflectance of the light transmission substrate 1 of the recording medium M is changed (recorded) with irradiation of ultraviolet rays and information can be recorded/reproduced by detecting (reproducing) the change of the transmittance of this light transmission substrate 1 or the change of the reflectance.

According to the recording medium, the recording and reproducing method and the recording and reproducing apparatus of the present invention, information can selectively be recorded on the light transmission substrate 1 irradiated with ultraviolet rays by the change of the transmittance of the substrate or the change of the reflectance.

According to the recording medium, the recording and reproducing method and the recording and reproducing apparatus of the present invention, in addition to the arrangement in which the change of the transmittance is detected, when a reflecting film having a proper reflectance, e.g., aluminum, silver, gold or the like is deposited on the substrate which had been irradiated with ultraviolet rays, the change of the transmittance or the change of the reflectance can be detected as the change of the amount of reflected light by the reflected light from the substrate.

According to the recording medium, the recording and reproducing method and the recording and reproducing apparatus of the present invention, the amount of the changed transmittance or the amount of the changed reflectance of the light transmission substrate can be arbitrarily adjusted in response to the irradiation time or/and the irradiation intensity. Thus, when information is recorded on the light transmission substrate, information can be recorded in a multi-value recording fashion by the amount of the changed transmittance or the reflectance. Specifically, not only information can be given to the length of the recorded marks used in the conventional optical disk but also information can be given to the amount of the changed transmittance or the changed reflectance of the recorded mark. At the same time, this arrangement can considerably contribute to a big increase of recording density at which information is recorded on the recording medium.

According to the recording medium, the recording and reproducing method and the recording and reproducing apparatus of the present invention, since information can be recorded on the light transmission substrate irreversibly and stably, it is possible to realize the recording medium, the recording and reproducing method and the recording and reproducing apparatus which are very suitable for recording information B such as identification information inherent in the recording medium that should preferably be prevented from being easily rewritten.

According to the recording medium, the recording and reproducing method and the recording and reproducing apparatus of the present invention, information recorded on the light transmission substrate of the recording medium can selectively be reproduced based on the wavelength of light for reproducing information. To be concrete, in the recording medium in which information is recorded and reproduced by using the red laser, for example, when the information B is recorded on the light transmission substrate of the recording medium according to the present invention by the change of the transmittance, information in which this information B can hardly be reproduced without the blue laser can be recorded on the recording medium in advance. For example, if this information B is recorded on the recording medium by the recording method according to the present invention in order to inhibit users in general from easily recording and reproducing identification information inherent in the recording medium and the like, then information B can be stored in the recording medium in such a manner that the information cannot be reproduced without using the blue laser.

According to the recording medium, the recording and reproducing method and the recording and reproducing apparatus of the present invention, inherent identification information, e.g., recording medium or recording information management information, recording/reproducing disapproving information, recording medium true and false authentication information, information of the number of times of recording/reproduction, user authentication information and the like can be added to the respective recording mediums arbitrarily as information B. As a result, there can be realized the recording medium which can hardly be duplicated, imitated and forged, its recording and reproducing method and its recording and reproducing apparatus.

Further, according to the recording medium, the recording and reproducing method and the recording and reproducing apparatus of the present invention, since the information A and B can be recorded and reproduced by laser light having different wavelengths, only a recording medium manager or manufacturer can detect the information B. As a result, there can be realized the recording medium which can hardly be duplicated, imitated and forged by users in general.

Furthermore, according to the present invention, since the light transmission substrate or the light transmission protecting film in which the information B can be recorded and reproduced can be made of suitable resin materials such as polycarbonate resin, PMMA resin and epoxy resin which are used as ordinary recording medium substrate or protecting film, any special materials need not be selected. Therefore, the recording medium and the recording and reproducing apparatus according to the present invention can be manufactured inexpensively.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

1-43. (canceled)

44. A recording and reproducing method for recording and reproducing information on and from a recording medium including a light transmission recording material and said light transmission recording material has a recording area in which information is to be recorded by at least one of a change of refractive index or a change of extinction coefficient said method comprising a step of irradiating light on said recording medium in order to record or reproduce said information.

45. A recording and reproducing method for recording and reproducing information on and from a recording medium including a light transmission recording material and said light transmission recording material has a recording area in which information is to be recorded by at least one of a change of transmittance or a change of reflectance, said method comprising a step of irradiating light on said recording medium in order to record or reproduce said information.

46. A recording and reproducing method for recording and reproducing information on and from a recording medium including at least one of a light transmission substrate and a light transmission protecting film and at least one of said light transmission substrate and said light transmission protecting film includes a recording area in which information B is to be recorded by at least one of a change of refractive index or a change of extinction coefficient, said method comprising a step of irradiating light on said recording medium in order to record or reproduce said information B.

47. A recording and reproducing method for recording and reproducing information on and from a recording medium including at least one of a light transmission substrate and a light transmission protecting film and a recording area of information A, wherein at least one of said light transmission substrate or said light transmission protecting film includes a recording area in which information B is recorded by at least one of a change of transmittance and a change of reflectance; said method comprising a step of irradiating light on said recording medium in order to record or reproduce said information B.

48. A recording and reproducing method for recording and reproducing information on and from a recording medium including a light transmission recording material and said light transmission recording material has a recording area in which information is to be recorded by at least one of a change of refractive index or a change of extinction coefficient, wherein electron beams are irradiated on said recording medium in order to record said information.

49. A recording and reproducing method for recording and reproducing information on and from a recording medium including a light transmission recording material and said light transmission recording material has a recording area in which information is to be recorded by at least one of a change of transmittance or a change of reflectance, said method comprising a step of irradiating electron beams on said recording medium in order to record said information.

50. A recording and reproducing method for recording and reproducing information on and from a recording medium including at least one of a light transmission substrate and a light transmission protecting film and a recording area of information A and at least one of said light transmission substrate and said light transmission protecting film includes a recording area in which information B is to be recorded by at least one of a change of refractive index or a change of extinction coefficient, said method comprising a step of irradiating electron beams on said recording medium in order to record said information B.

51. A recording and reproducing method for recording and reproducing information on and from a recording medium including at least one of a light transmission substrate and a light transmission protecting film and a recording area of information A and at least one of said light transmission substrate and said light transmission protecting film includes a recording area in which information B is to be recorded by at least one of a change of transmittance or a change of reflectance, said method comprising a step of irradiating electron beams on said recording medium in order to record said information B.

52. A recording and reproducing method according to claim 44 or 45, wherein said recording medium is irradiated with ultraviolet rays in said light irradiation step.

53. A recording and reproducing method according to claim 46 or 47, wherein said recording medium is irradiated with ultraviolet rays in said light irradiation step.

54. A recording and reproducing method according to claim 44 or 45, wherein said light transmission recording material is irradiated with reproducing light and said information is reproduced by a change of light amount of passing light of said reproducing light or a change of light amount of reflected light of said reproducing light in said light irradiation step.

55. A recording and reproducing method according to claim 46 or 47, wherein said light transmission recording material is irradiated with reproducing light and said information B is reproduced by a change of light amount of passing light of reproducing light or a change of light amount of reflected light in said light irradiation step.

56. A recording and reproducing method according to claim 46 or 47, wherein said information A is recorded with irradiation of light having a wavelength λra and said information A is reproduced with light having a wavelength λpb in said light irradiation step, said information B is recorded with irradiation of light having a wavelength λrb and said information B is reproduced with irradiation of light having a wavelength λpb in said light irradiation step and said λra, λpa, λrb, λpb satisfy more than any one of relationship of λra=λpa, λra≠λpa, λrb=λpb, λrb≠λpb, λra=λrb, λra≠λrb, λpa=λpb, λpa≠λpb, λra=λpb, λra≠λpb, λpa=λrb, λpa≠λrb.

57. A recording and reproducing method according to claim 46 or 47, wherein said recording medium has a recording area of said information A in which said information A is reproduced with irradiation of light having a wavelength λpa and said information A is reproduced without irradiation of light, said information B is recorded on said light transmission substrate or said light transmission protecting film with irradiation of light having a wavelength λrb and said information B is reproduced from said light transmission substrate or said light transmission protecting film with irradiation of light having a wavelength λpb in said light irradiation step and said λpa, λrb, λpb satisfy more than any one relationship of λrb=λpb, λrb≠λpb, λpa=λpb, λpa≠λpb, λpa=λrb, λpa≠λrb.

58. A recording and reproducing method according to claim 46 or 47, wherein said light irradiation step includes a step of reproducing information B and a step of recording or reproducing information A based on reproducing information of said information B.

59. A recording and reproducing method according to claim 46 or 47, wherein said information B contains inherent identification information and said light irradiation step includes a step of recording or reproducing information A based on reproducing information of said inherent identification information of said information B.

60. A recording and reproducing method according to claim 46 or 47, wherein said information B contains inherent identification information, said inherent identification information contains at least one of management information of recording medium, management information of recording information, recording disapproving information, reproduction disapproving information, true and false information of recording medium, recording number limiting information, reproduction number limiting information and user authentication information and said light irradiation step includes a step of recording or reproducing information A based on reproducing information of said inherent identification information of said information B.

61. A recording and reproducing method according to claim 46 or 47, wherein said recording area of said information A includes information relating to said information B and said light irradiation step includes a step of reproducing information relating to said information B of said information A, a step of reproducing said information B based on information relating to said information B and a step of recording or reproducing said information A by judgment based on reproduced information of said information B.

62. A recording and reproducing method according to claim 44 or 45, wherein said light irradiation step includes a step of recording said information as information based on at least any one of a change of multi-value refractive index or a change of multi-value extinction coefficient or at least one of a change of multi-value transmittance or a change of multi-value reflectance by at least one of a change of ultraviolet ray irradiation time, ultraviolet ray irradiation intensity and light amount of irradiated ultraviolet rays.

63. A recording and reproducing method according to claim 46 or 47, wherein said light irradiation step includes a step of recording said information 13 as information based on at least any one of a change of multi-value multi-active index or a change of multi-value extinction coefficient or at least any one of a change of multi-value transmittance or a change of multi-value reflectance by at least a change of ultraviolet ray irradiation time, ultraviolet ray irradiation intensity and light amount of irradiated ultraviolet rays.

64. A recording and reproducing method according to claim 44 or 45, wherein said light irradiation step includes a step of reproducing information B by at least any one of a change of multi-value refractive index or a change of multi-value extinction coefficient or by at least any one of a change of multi-value transmittance or a change of multi-value reflectance and said reproducing step detects a change of multi-value light amount of passing light or a change of multi-value reflected light of reproducing light irradiated on said recording medium.

65. A recording and reproducing method according to claim 46 or 47, wherein said light irradiation step includes a step of reproducing information B by at least any one of a change of multi-value refractive index or a change of multi-value extinction coefficient or by at least any one of a change of multi-value transmittance or a change of multi-value reflectance and a change of multi-value light amount of passing light or a change of multi-value light amount of reflected light of reproducing light irradiated on said recording medium by said reproducing step.

66. A recording and reproducing method according to claim 44 or 45, wherein said light irradiation step includes a step of recording said information as information based on at least any one of a continuous change of multi-value refractive index or a continuous change of multi-value extinction coefficient or at least any one of a continuous change of multi-value transmittance or a continuous change of multi-value reflectance by at least one change of ultraviolet ray irradiation time, ultraviolet ray irradiation intensity and ultraviolet ray irradiation light amount.

67. A recording and reproducing method according to claim 46 or 47, wherein said light irradiation step includes a step of recording said information B as information based on at least any one of a continuous change of multi-value refractive index or a continuous change of multi-value extinction coefficient or at least any one of a continuous change of multi-value transmittance or a continuous change of multi-value reflectance by at least one change of ultraviolet ray irradiation time, ultraviolet ray irradiation intensity and ultraviolet ray irradiation light amount.

68. A recording and reproducing method according to claim 44 or 45, wherein said light irradiation step includes a step of reproducing information by at least any one of a continuous change of multi-value refractive index or a continuous change of multi-value extinction coefficient or by at least any one of a continuous change of multi-value transmittance or a continuous change of multi-value reflectance and continuous change of multi-value light amount of passing light or a continuous change of multi-value light amount of reflected light of reproducing light irradiated on said recording medium is detected by said reproducing step.

69. A recording and reproducing method according to claim 46 or 47, wherein said light irradiation step includes a step of reproducing information B by at least any one of a continuous change of multi-value refractive index or a continuous change of multi-value extinction coefficient or at least any one of a continuous change of multi-value transmittance or a continuous change of multi-value reflectance and a continuous change of multi-value light amount of passing light or a continuous change of multi-value light amount of reflected light of reproducing light irradiated on said recording medium is detected by said reproducing step.

70-93. (canceled)
